(19) United States
(12) Patent Application Publication
(10) Pub. No.: US 2026/0143451 A1
(43) Pub. Date: May 21, 2026

(54) Positioning based on Multiple Complementary Operations

(71) Applicant: Telefonaktiebolaget LM Ericsson (publ), Stockholm (SE)

(72) Inventors: Iana Siomina, Täby (SE); Ritesh Shreevastav, Upplands Väsby (SE); Lu Zhang, Beijing (CN)

(21) Appl. No.: 19/121,665

(22) PCT Filed: Oct. 17, 2023
(86) PCT No.: PCT/CN2023/124869

§ 371 Date: Apr. 16, 2025

(30) Foreign Application Priority Data
Oct. 20, 2022 (WO) PCT/CN2022/126431
Apr. 21, 2023 (WO) PCT/CN2023/089932

(51) Int. Cl. H04W 64/00

(52) U.S. Cl. CPC H04W 64/00

(57) ABSTRACT

The present disclosure is related to a terminal device, network nodes, and methods for positioning based on multiple complementary operations. A method at a first terminal device for positioning a target that is associated with multiple terminal devices comprising the first terminal device comprises: obtaining a first association with at least one second terminal device from the multiple terminal devices other than the first terminal device, wherein the first terminal device is able to perform a first operation for positioning, and the at least one second terminal device is able to perform at least one second operation for positioning that is complementary to the first operation; and performing the first operation for positioning the target.

### CROSS-REFERENCE TO RELATED APPLICATION(S)

This application claims priority to the PCT International Application No. PCT/CN2022/126431, entitled “IMPROVED TARGET POSITIONING BY USING MUL TIPLE TERMINAL DEVICES”, filed on Oct. 20, 2022 and the PCT International Application No. PCT/CN2023/089932, entitled “POSITIONING BASED ON MULTIPLE COMPLEMENTARY OPERATIONS”, filed on Apr. 21, 2023, which are incorporated herein by reference in their entireties.

### TECHNICAL FIELD

The present disclosure is related to the field of telecommunication, and in particular, to network nodes, a terminal device, and methods for positioning based on multiple complementary operations.

### BACKGROUND

With the development of the electronic and telecommunication technologies, mobile devices, such as a mobile phone, a smart phone, a laptop, a tablet, a vehicle mounted device, becomes an important part of our daily lives. One of the key features provided by a mobile device is location-based service (LBS). Because of the popularities of social networks and the widespread usage of mobile devices, demands for LBS are increased in both indoor and outdoor environments.

Positioning could be done with or without utilizing cellular mobile communication networks (e.g., 4^{th} Generation (4G) Long Term Evolution (LTE) or 5^{th} Generation (5G) New Radio (NR) networks).

There are many positioning schemes without utilizing cellular mobile communication networks (i.e., the third-party schemes), for example, the schemes may exploit some certain combinations of the following technologies: Wi-Fi fingerprinting, ZigBee/Bluetooth fingerprinting, geomagnetic fingerprinting, inertial navigation, Radio Frequency Identification (RFID), Ultra Wideband (UWB) communications, visible light communications, ultrasonic wave, infrared ray, map matching, etc.

For positioning schemes with utilizing cellular mobile communication networks (i.e., cellular-based positioning), several traditional positioning methods exist in the 4G standards and can be naturally applied to 5G networks. Here, below is a non-exhaustive list of technologies that vendors and operators have at the moment and are likely to investigate first for the positioning service.
Enhanced cell identification (E-CID): E-CID offers a range of measurements for positioning purposes: angle-of-arrival/departure (AoA/AoD), received signal strength with path-loss model (RSSPLM), timing advance type 1 (TADV1, essentially a round trip time) or type 2 (TADV2)
“Relative time difference” based positioning (or called ranging based positioning): Typically, this kind of methods include observed or uplink time difference of arrival (OTDoA or UTDoA), which are called Downlink TDoA (DL-TDoA) or Uplink TDoA (UL-TDoA) in 5G standards, respectively. These two methods are both multilateration techniques based on relative timing measurements (DL-TDOA is based on DL Reference Signal Time Difference (RSTD), and UL TDoA is based on UL Relative Time of Arrival (RTOA)). The RSTD is the time of arrivals (ToA) difference of RS received from one transmission point and another RS from another (reference) transmission point. A conventional method to estimate the ToA is to find the time delay at which the correlation between the RS and the received signal has its maximum.
Radio Frequency (RF) pattern matching (or called fingerprinting) which is often used for indoor positioning: This method needs a database of signal fingerprints associated with different geographic positions. Typically a fingerprint of a certain location is associated with at least a signal measurement, such as the received signal strength (RSS). The location of the positioned target is estimated by comparing online measurements with a set of training samples at known positions. There are some obvious drawbacks for this method, e.g., the fingerprint feature(s) of each location have to be measured prior to location estimation, the locations with similar fingerprint feature(s) may be hard to be distinguished, and a previously collected fingerprint might not remain accurate in dynamic environments.
Assisted Global Navigation Satellite System (A-GNSS) which is generally used for outdoor positioning: This method is used to significantly improve the startup performance of a global navigation satellite system (GNSS). Specifically, this method works by supplying the necessary information (e.g., almanac, ephemeris) to the user device via a cellular network instead of the slow satellite link, essentially helping the GNSS receiver achieve a faster time-to-first-fix. The reason why A-GNSS is not used for indoor positioning is that satellite signals would generally be lost in indoor scenarios.

Further, 5G also introduces some new positioning methods, some of which are briefly summarized below.
A new “relative time difference” based positioning method: This method is based on multi-cell round-trip time (multi-RTT) measurements. For multi-RTT positioning method, after gNBs and User Equipments (UEs) transmit Positioning Reference Signal (PRS) in downlink and Sounding Reference Signal (SRS) in uplink, respectively, the UE reports the measurement results to the Location Management Function (LMF) and the gNB reports the measurements to the LMF. By doing so, the round-trip time can be estimated and therefore ToA of one-way signal propagation between the UE and the gNB can be estimated. This method is robust against network time synchronization errors.
Angle based positioning: This kind of methods include downlink angle of departure (DL-AoD) and uplink angle of arrival (UL-AoA), which are more relevant with the usage of millimeter-wave (mmWave) and multiple antennas in 5G NR. For DL-AoD positioning method, UE provides the PRS beam received signal received power (RSRP) measurements to LMF and the gNB provides the beam azimuth and elevation angular information to LMF. For UL-AoA positioning method, the UE location is estimated based on the SRS AoA measurements taken at different antenna reception points (ARPs) of the antenna array of a Transmission/Reception Point (TRP) or at different TRPs. For either DL-AoD or UL-AoA method, LMF estimates the UE location by using the angle information, along with other configuration and deployment information, such as ARPs' center locations (or TRPs' coordinates) and beam configuration details.

### SUMMARY

To improve the positioning accuracy and integrity for cellular-based positioning, an international patent application, PCT/CN2022/126431, proposes an enhanced positioning scheme by exploiting multiple UEs on a same target to be positioned. A brief introduction of the enhanced positioning scheme is given below.

Considering a case where a target to be positioned (which could be either a human being or an object) carries two (or even more) 5G UEs, each of which can be a regular 5G UE, or a RedCap (reduced capability) 5G UE, or a further simplified mMTC-type UE. In practice, it is increasingly popular for a human to carry two or more UEs. Further, when there is a need for positioning a target, multiple UEs can be intentionally carried by, disposed at, installed at, attached to, or otherwise co-located with this target in advance, especially when this target is an object.

Upon using a “relative time difference” based positioning scheme (such as DL-TDoA/UL-TDoA/multi-RTT scheme), each of J (J≥2) 5G UEs, which are carried by a target to be positioned, can result in RSTDs upon the corresponding PRS/SRS ToA measurements. If the RSTD resulted by PRS/SRS transmissions between the reference access point and a neighboring access point i is denoted as RSTD_{0,i}, then, for every available i, the RSTD_{0,i} can be obtained via doing proper “syncretic processing” on the ToAs measured by J 5G UEs.

Specifically, the proposed three ways of syncretic processing include:

1) Among J (J≥2) 5G UEs, if there is at least one “all-line-of-sight-path UE or all-LOS-path UE” whose ToA measurements are all LOS-path resulted ToA measurements, it is recommended to select the ToA measurements of one of the “all-LOS-path UEs” as the output of the syncretic processing. This way can be viewed as prioritizing LOS-resulted ToA with the prioritization granularity being UE.

2) Among J (J≥2) 5G UEs, if there is no “all-LOS-path UE”, the mainly recommended way of syncretic processing is arithmetic average processing. In particular, either a uniform average or a weighted average may be performed with the weights being designed upon “path PRS RSRPs”.

3) To cover all possibly reasonable ways, the following ways can be considered as optional ways (which can be viewed as prioritizing LOS-resulted ToA with the prioritization granularity being ToA):
3.1) Using two 5G UEs as an example, if the ToAs measured by these two UEs for PRS transmissions from an available access point include one LOS-resulted ToA and one Non-Line-Of-Sight (NLOS) resulted ToA, then the ToA from the considered access point to the target to be positioned is determined as that LOS-resulted ToA. This optional way of syncretic processing will achieve performance gain only when “the two 5G UEs are located closely enough” and “NLOS-resulted ToA offset is large enough”.
3.2) Using two 5G UEs as an example, if the ToAs measured by these two UEs for PRS transmissions from an available access point include two LOS-resulted ToAs, then the ToA from the considered access point to the target to be positioned is determined as the one with a larger LOS-path PRS RSRP. This optional way of syncretic processing will achieve performance gain only when “the two 5G UEs are located closely enough”.

The way for signaling the information about the association between the J (J≥2) UEs:

Option 1: The association information is only signaled from a location service (LCS) Client to an LMF, via the interface between the LCS Client and a Gateway Mobile Location Center (GMLC), the interface between the GMLC and an Access and Mobility Management Function (AMF), and the interface between the AMF and the LMF. The syncretic processing on the ToAs measured by multiple UEs is performed at the LMF, and the proposed multi-UE positioning scheme is transparent to access points and UEs. Each of J UEs needs to feed back the ToA measurements over the air interface.

Option 2: On top of the above-mentioned Option 1, the association information is further signaled to the access points, via the interface between the AMF and the access points. The syncretic processing on the ToAs measured by multiple UEs can be performed at the access point(s), and the proposed multi-UE positioning scheme is just transparent to UEs. Although each of j UEs still needs to feed back the ToA measurements over the air interface, the number of ToA measurements sent from the involved access points to the LMF is less.

Option 3: On top of the abovementioned Option 2, the association information is further signaled to the UEs, via the interface between the UEs and their serving access point(s). The syncretic processing on the ToAs measured by the multiple UEs can be performed at one of j UEs, where UE aggregation is utilized to enable other UEs to send their measurements to the chosen one UE via using a UE-UE interconnection (e.g., Wi-Fi, Bluetooth). Only one of J UEs needs to feed back the syncretized ToA measurements over the air interface.

Further, a method for determining whether multiple UEs are really carried by a target to be positioned is provided as follows:
When the target to be positioned is an object, it is possible that one of J (J≥2) 5G UEs is accidentally lost although the probability of this kind of event is small. When the target to be positioned is a human being, it is possible that this person sometimes forgets to carry one of J 5G UEs even if the probability of this kind of event is not large. Thus, it is needed to design an appropriate way to determine whether J UEs are really carried by the target to be positioned or not.

Using DL-TDoA as an example of the used “relative time difference” based positioning scheme, the designed method includes the following two steps:

Step 1: Check whether the serving cell IDs of the J UEs are the same one.

Step 2: After the check at Step 1 is passed, check whether the measured PRS RSRPs of the J UEs for “any one given PRS resource which can be received and measured by these J UEs” have enough small relative differences.

With this method, it can be determined whether all J 5G UEs are really carried by the target to be positioned or not.

However, the multi-UE positioning described in the international patent application, PCT/CN2022/126431, does not describe positioning in the scenario with a group of complementary UEs or UEs with complementary responsibilities. For example, in the international patent application, PCT/CN2022/126431, the UEs receive and measure PRS over a same radio resource set or transmit same SRS over a same radio resource set. Therefore, if radio signals over a same radio resource set are severely interfered (e.g., due to a frequency-selective interference), then the accuracy and integrity of the multi-UE positioning will be deteriorated dramatically, especially when most of the UEs in the group have a limited capability (e.g., a RedCap UE, a NB-IoT UE).

Therefore, to address or at least alleviate at least one of the above issues, some embodiments of the present disclosure are provided.

According to a first aspect of the present disclosure, a method at a first terminal device for positioning a target that is associated with multiple terminal devices comprising the first terminal device is provided. The method comprises: obtaining a first association with at least one second terminal device from the multiple terminal devices other than the first terminal device, the first terminal device is able to perform a first operation for positioning, and the at least one second terminal device is able to perform at least one second operation for positioning that is complementary to the first operation; and performing the first operation for positioning the target.

In some embodiments, the first terminal device comprises a primary device among the multiple terminal devices. In some embodiments, the first operation and the at least one second operation comprise at least one of: radio signal transmission for positioning; radio signal reception for positioning; and performing a radio measurement for positioning. In some embodiments, the first association is formed based on at least the proximity. In some embodiments, the method further comprises at least one of: transmitting, to the at least one second terminal device, a message indicating or comprising a first result of the first operation; receiving, from a network node, a message comprising a positioning configuration for assisting the first terminal in performing the first operation; receiving, from a network node, a message comprising a positioning configuration for assisting the at least one second terminal in performing the second operation; receiving, from a network node, a message indicating or comprising a positioning result, based at least on the first operation and the at least one second operation; transmitting, to the at least one second terminal device, a message indicating or comprising a positioning configuration to assist the at least one second terminal device in performing the at least one second operation; transmitting, to a network node, a message indicating the first result of the first operation; receiving, from the at least one second terminal device, a message indicating at least one second result of the at least one second operation; transmitting, to a network node, a message indicating the at least one second result of the at least one second operation when the at least one second result is received from the at least one second terminal device; and obtaining a positioning result for the target, the positioning result is based on at least the first result of the first operation and/or the at least one second result of the at least one second operation, the obtaining comprises determining in the first terminal device or receiving from a network node. In some embodiments, a positioning configuration comprises at least one of: a configuration for radio signals to be transmitted for positioning; a configuration for radio signals to be received for positioning; and a configuration for positioning measurement.

In some embodiments, the first operation is complementary to the at least one second operation in terms of radio resource sets associated to the first operation and the at least one second operation. In some embodiments, a union of a first radio resource set associated with the first operation and at least one second radio resource set associated with the at least one second operation is a proper superset of the first radio resource set and a proper superset of the at least one second radio resource set. In some embodiments, the first radio resource set is not overlapped with the second radio resource set in the frequency domain, or in the time domain, or in both of the frequency domain and the time domain.

In some embodiments, the first operation comprises at least one of: transmitting first radio signals over a first radio resource set associated with the first operation that is complementary to a second radio resource set associated with the at least one second operation; receiving second radio signals over a first radio resource set associated with the first operation that is complementary to a second radio resource set associated with the at least one second operation; and performing one or more measurements over a first radio resource set associated with the first operation that is complementary to a second radio resource set associated with the at least one second operation. In some embodiments, the first radio signals are Sounding Reference Signals (SRS). In some embodiments, the second radio signals are Positioning Reference Signals (PRS).

In some embodiments, before the step of performing the first operation, the method further comprises at least one of: informing one or more network nodes about a first positioning capability of the first terminal device; and informing one or more network nodes about a positioning capability comprising a first positioning capability of the first terminal device and at least one second positioning capability of the at least one second terminal device. In some embodiments, before the step of informing the one or more network nodes about the first positioning capability, the method further comprises: receiving, from the at least one second terminal device, a message indicating at least one second positioning capability of the at least one second terminal device, the step of informing the one or more network nodes about the first positioning capability comprises: informing the one or more network nodes about both the first positioning capability and the at least one second positioning capability. In some embodiments, the one or more network nodes are informed about the first positioning capability by the first terminal device via the at least one second terminal device. In some embodiments, the method further comprises: receiving, from the one or more network nodes and/or the at least one second terminal device, a message indicating a first positioning configuration for the first terminal device, the step of performing the first operation is based on at least the first positioning configuration.

In some embodiments, when at least one second positioning configuration for the at least one second terminal device is received by the first terminal device from the one or more network nodes, the method further comprises: transmitting, to each of the at least one second terminal device, a message indicating a corresponding one of the at least one second positioning configuration. In some embodiments, the one or more network nodes comprise at least one of: a Radio Access Network (RAN) node; a positioning node; an Access and Mobility Management Function (AMF); a Location Measurement Unit (LMU); an Enhanced Serving Mobile Location Centre (E-SMLC); and a Location Management Function (LMF).

In some embodiments, a positioning configuration for a terminal device comprises at least one of: a configuration indicating an uplink (UL) radio resource set for the terminal device to transmit SRS; a configuration indicating a downlink (DL) radio resource set for the terminal device to receive PRS; and a measurement configuration for the terminal device to perform a measurement based on at least one of SRS and PRS. In some embodiments, after the step of transmitting the first result, the method further comprises at least one of: receiving, from the at least one second terminal device, a positioning result for the target; receiving, from a network node, a positioning result for the target; refining the positioning result, when it is received from the network node, based on relative delays and/or offsets between members in the first association; and transmitting, to the at least one second terminal device, the positioning result, when it is received from the network node, or the refined positioning result.

In some embodiments, the first association has a higher physical proximity level for its members than a threshold. In some embodiments, the threshold is determined by at least one of: a pre-configuration; a dynamic configuration by an application; a dynamic configuration by a network node or another terminal device; and relative locations of the members in the first association. In some embodiments, the method further comprises at least one of: associating the first terminal device with a third terminal device based on at least the third terminal device's physical proximity level to at least one member in the first association, such that the third terminal device joins the first association; and disassociating the first terminal device from another terminal device in the first association based on at least the other terminal device's physical proximity level to one or more of other members in the first association, such that the other terminal device leaves the first association.

In some embodiments, the first terminal device is not able to obtain another association than the first association. In some embodiments, the first terminal device is able to obtain one or more other associations than the first association. In some embodiments, each of the one or more other associations has a physical proximity level different from that of the first association. In some embodiments, each of the one or more other associations is associated with an application different from that associated with the first association. In some embodiments, each of the one or more other associations is associated with a delay or timing different from that associated with the first association. In some embodiments, each of the one or more other associations is associated with an identifier different from that associated with the first association.

In some embodiments, the members in the first association have at least one of: a same ownership; a same synchronization reference source; same group communication; registrations to a same list; sign-ins under a same identifier; a same associated positioning request or measurement request; a same associated positioning result; a same quasi-collocation (QCL) type; a common timing-related group; a common ID associated with the first association; for at least one radio measurement type, related measurement results that are close to each other to an extent defined by one or more thresholds; and a same user or same carrier at the time of obtaining the first association. In some embodiments, the measurement results that are close to each other to an extent defined by one or more thresholds comprise at least one of: Reference Signal Received Powers (RSRPs) measured by the members in the first association that do not differ from each other by more than a threshold; measurement results for Doppler measurements performed by the members in the first association that do not differ from each other by more than a threshold; and Time of Arrivals (ToAs) measured for the members in the first association that do not differ from each other by more than a threshold.

In some embodiments, the first terminal device is a primary terminal device for the first association. In some embodiments, with respect to other members in the first association, the first terminal device has at least one of: a better connection to the network; a higher power; a higher capacity; more battery energy left; and a capability of enabling synchronization within the group. In some embodiments, the primary terminal device is able to perform at least one of: configuring other members in the first association; maintaining a list of members in the first association; verifying whether a member in the first association still meets a condition for being in the first association; informing a network node about a status of the first association; acting towards at least one other node on behalf of members in the first association; relaying data between at least one member in the first association and a node external to the first association; distributing or forwarding, to members in the first association, at least some of the data and/or information and/or configuration received from a network node; obtaining resources for the first association; configuring complementary resources for individual members in the first association; obtaining and/or determining and/or reporting a combined measurement result to a network node based on results of complementary operations of members in the first association; being or providing a synchronization reference for other members in the first association; collecting radio measurements within the first association; forwarding or sending assistance data to members in the first association; triggering members in the first association to perform at least one positioning measurement; comprising a Service Client for the first association if the Service Client resides in the terminal device side; and performing resource coordination or allocation among members in the first association.

In some embodiments, the primary terminal device is able to be a QCL reference for other terminal devices in the first association. In some embodiments, the primary terminal device is able to be used as a reference location for at least one of other terminal devices in the first association. In some embodiments, radio resource sets associated with the members in the first associations are consecutive in the frequency domain and aligned in the time domain. In some embodiments, signals transmitted by the members in the first association over the radio resource sets associated with the members in the first association are able to be received and/or processed by a same node as a combined signal transmitted over a bandwidth comprising the individual bandwidths of the individual radio resource sets associated with the individual members in the first association. In some embodiments, signals received by the members in the first association over the radio resource sets associated with the members in the first association are able to be combined and processed as a combined signal received over a bandwidth comprising the individual bandwidths of the individual radio resource sets associated with the individual members in the first association. In some embodiments, measurement results measured by the members in the first association over the radio resource sets associated with the members in the first association are able to be combined and processed as a combined measurement result measured over a bandwidth comprising the individual bandwidths of the individual radio resource sets associated with the individual members in the first association.

According to a second aspect of the present disclosure, a terminal device is provided. The terminal device comprises: a processor; a memory storing instructions which, when executed by the processor, cause the processor to carry out any of the methods of the first aspect.

According to a third aspect of the present disclosure, a first terminal device for positioning a target that is associated with multiple terminal devices comprising the first terminal device is provided. The first terminal device comprises: an obtaining module configured to obtain a first association with at least one second terminal device from the multiple terminal devices other than the first terminal device, the first terminal device is able to perform a first operation for positioning, and the at least one second terminal device is able to perform at least one second operation for positioning that is complementary to the first operation; and a performing module configured to perform the first operation for positioning the target. In some embodiments, the terminal device may comprise one or more further modules, each of which may perform any of the steps of any of the methods of the first aspect.

According to a fourth aspect of the present disclosure, a method at a network node for positioning a target associated with multiple terminal devices comprising a first terminal device is provided. The method comprises: determining that a first association is obtained among the first terminal device and at least one second terminal device from the multiple terminal devices other than the first terminal device, the first terminal device is able to perform a first operation for positioning, and the at least one second terminal device is able to perform at least one second operation for positioning that is complementary to the first operation; and performing one or more third operations corresponding to the first operation and the at least one second operation for positioning the target.

In some embodiments, the first terminal device comprises a primary device among the multiple terminal devices. In some embodiments, the first operation, the at least one second operation, and the one or more third operations comprise at least one of: radio signal transmission for positioning; radio signal reception for positioning; and performing a radio measurement for positioning. In some embodiments, the first association is formed based on at least the proximity. In some embodiments, the method further comprises at least one of: receiving, from one or more members in the first association, one or more messages indicating a first result of the first operation and/or at least one second result of the at least one second operation; transmitting, to the first terminal device and/or the at least one second terminal device, a message comprising a positioning configuration for assisting the first terminal in performing the first operation; transmitting, to the first terminal device and/or the at least one second terminal device, a message comprising a positioning configuration for assisting the at least one second terminal in performing the second operation; transmitting, to the first terminal device and/or the at least one second terminal device, a message indicating or comprising a positioning result, based at least on the first operation and the at least one second operation; transmitting, to one or more nodes, one or more messages indicating at least one of the first result, the at least one second result, and one or more third results of the one or more third operations; and obtaining a positioning result for the target, the positioning result is based on at least one of the first result, the at least one second result, and the one or more third results, the obtaining comprises determining in the first terminal device or receiving from a network node. In some embodiments, a positioning configuration comprises at least one of: a configuration for radio signals to be transmitted for positioning; a configuration for radio signals to be received for positioning; and a configuration for positioning measurement.

In some embodiments, the first operation is complementary to the at least one second operation in terms of radio resource sets associated to the first operation and the at least one second operation. In some embodiments, a union of a first radio resource set associated with the first operation and at least one second radio resource set associated with the at least one second operation is a proper superset of the first radio resource set and also a proper superset of the at least one second radio resource set. In some embodiments, the first radio resource set is not overlapped with the second radio resource set in the frequency domain, or in the time domain, or in both of the frequency domain and the time domain.

In some embodiments, the one or more third operations comprise at least one of: receiving first radio signals over one or more radio resource sets associated with one or more complementary operations performed by one or more members in the first association; transmitting second radio signals over one or more radio resource sets associated with one or more complementary operations performed by one or more members in the first association; performing one or more measurements over one or more radio resource sets associated with one or more complementary operations performed by one or more members in the first association. In some embodiments, the first radio signals are Sounding Reference Signals (SRS). In some embodiments, the second radio signals are Positioning Reference Signals (PRS).

In some embodiments, before the step of performing the one or more third operations, the method further comprises at least one of: receiving, from one or more members in the first association, one or more messages indicating one or more positioning capabilities of the one or more members in the first association. In some embodiments, the method further comprises at least one of: receiving, from one or more other network nodes, one or more messages indicating one or more positioning configurations for the one or more members in the first association; and transmitting, to the one or more members in the first association, one or more messages indicating one or more positioning configurations for the one or more members in the first association.

In some embodiments, the network node comprises at least one of: a Radio Access Network (RAN) node; a positioning node; an Access and Mobility Management Function (AMF); a Location Measurement Unit (LMU); an Enhanced Serving Mobile Location Centre (E-SMLC); and a Location Management Function (LMF). In some embodiments, a positioning configuration for a member in the first association comprises at least one of: a configuration indicating an uplink (UL) radio resource set for the member to transmit SRS; a configuration indicating a downlink (DL) radio resource set for the member to receive PRS; and a measurement configuration for the member to perform a measurement based on at least one of SRS and PRS.

In some embodiments, after the step of positioning the target, the method further comprises at least one of: transmitting, to one or more members in the first association, one or more messages indicating a positioning result for the target. In some embodiments, the first association has a higher physical proximity level for its members than a threshold. In some embodiments, the threshold is determined by at least one of: a pre-configuration; a dynamic configuration by an application; a dynamic configuration by a network node or another terminal device; and relative locations of the members in the first association.

In some embodiments, the method further comprises at least one of: configuring one or more members in the association and a third terminal device based on at least the third terminal device's physical proximity level to at least one member in the first association such that the third terminal device joins the first association; receiving, from one or more members in the association, one or more messages indicating that a third terminal device joins the first association; configuring one or more members in the association based on at least a member terminal device's physical proximity level to other members in the first association such that the member terminal device in the first association leaves the first association; and receiving, from one or more members in the association, one or more messages indicating that a member in the first association leaves the first association.

In some embodiments, the method further comprises: determining that one or more other associations than the first association are obtained by the first terminal device. In some embodiments, each of the one or more other associations has a physical proximity level different from that of the first association. In some embodiments, each of the one or more other associations is associated with an application different from that associated with the first association. In some embodiments, each of the one or more other associations is associated with a delay or timing different from that associated with the first association. In some embodiments, each of the one or more other associations is associated with an identifier different from that associated with the first association.

In some embodiments, the members in the first association have at least one of: a same ownership; a same synchronization reference source; same group communication; registrations to a same list; sign-ins under a same identifier; a same associated positioning request or measurement request; a same associated positioning result; a same quasi-collocation (QCL) type; a common timing-related group; a common ID associated with the first association; for at least one radio measurement type, related measurement results that are close to each other to an extent defined by one or more thresholds. In some embodiments, the measurement results that are close to each other to an extent defined by one or more thresholds comprise at least one of: Reference Signal Received Powers (RSRPs) measured by the members in the first association that do not differ from each other by more than a threshold; measurement results for Doppler measurements performed by the members in the first association that do not differ from each other by more than a threshold; and Time of Arrivals (ToAs) measured for the members in the first association that do not differ from each other by more than a threshold.

In some embodiments, the method further comprises: determining that the first terminal device is a primary terminal device for the first association. In some embodiments, with respect to other members in the first association, the first terminal device has at least one of: a better connection to the network; a higher power; a higher capacity; more battery energy left; and a capability of enabling synchronization within the group. In some embodiments, the primary terminal device is able to perform at least one of: configuring other members in the first association; maintaining a list of members in the first association; verifying whether a member in the first association still meets a condition for being in the first association; informing a network node about a status of the first association; acting towards at least one other node on behalf of members in the first association; relaying data between at least one member in the first association and a node external to the first association; distributing or forwarding, to members in the first association, at least some of the data and/or information and/or configuration received from a network node; obtaining resources for the first association; configuring complementary resources for individual members in the first association; obtaining and/or determining and/or reporting a combined measurement result to a network node based on results of complementary operations of members in the first association; being or providing a synchronization reference for other members in the first association; collecting radio measurements within the first association; forwarding or sending assistance data to members in the first association; triggering members in the first association to perform at least one positioning measurement; comprising a Service Client for the first association if the Service Client resides in the terminal device side; and performing resource coordination or allocation among members in the first association.

In some embodiments, the primary terminal device is able to be a QCL reference for other terminal devices in the first association. In some embodiments, the primary terminal device is able to be used as a reference location for at least one of other terminal devices in the first association. In some embodiments, radio resource sets associated with the members in the first associations are consecutive in the frequency domain and aligned in the time domain. In some embodiments, signals transmitted by the members in the first association over the radio resource sets associated with the members in the first association are able to be received and/or processed by the network node as a combined signal transmitted over a bandwidth comprising the individual bandwidths of the individual radio resource sets associated with the individual members in the first association. In some embodiments, signals transmitted by the network node over the radio resource sets associated with the members in the first association are able to be received by the members in the first association, respectively, and combined and processed as a combined signal received over a bandwidth comprising the individual bandwidths of the individual radio resource sets associated with the individual members in the first association. In some embodiments, signals transmitted by the network node over the radio resource sets associated with the members in the first association are able to be measured by the members in the first association, respectively, and measurement results are able to be combined and processed as a combined measurement result measured over a bandwidth comprising the individual bandwidths of the individual radio resource sets associated with the individual members in the first association.

According to a fifth aspect of the present disclosure, a network node is provided. The network node comprises: a processor; a memory storing instructions which, when executed by the processor, cause the processor to carry out any of the methods of the fourth aspect.

According to a sixth aspect of the present disclosure, a network node for positioning a target associated with multiple terminal devices comprising a first terminal device is provided. The network node comprises: a determining module configured to determine that a first association is obtained among the first terminal device and at least one second terminal device from the multiple terminal devices other than the first terminal device, the first terminal device is able to perform a first operation for positioning, and the at least one second terminal device is able to perform at least one second operation for positioning that is complementary to the first operation; and a performing module configured to perform one or more third operations corresponding to the first operation and the at least one second operation for positioning the target. In some embodiments, the network node may comprise one or more further modules, each of which may perform any of the steps of any of the methods of the fourth aspect.

According to a seventh aspect of the present disclosure, a computer program comprising instructions is provided. The instructions, when executed by at least one processor, cause the at least one processor to carry out any of the methods of at least one of the first and fourth aspects.

According to an eighth aspect of the present disclosure, a carrier containing the computer program of the seventh aspect is provided. In some embodiments, the carrier may be one of an electronic signal, optical signal, radio signal, or computer readable storage medium.

According to a ninth aspect of the present disclosure, a telecommunication system for positioning a target associated with multiple terminal devices comprising a first terminal device is provided. The telecommunication system comprises: the first terminal device comprising: a processor; a memory storing instructions which, when executed by the processor, cause the processor to: obtain a first association with at least one second terminal device from the multiple terminal devices other than the first terminal device, the first terminal device is able to perform a first operation for positioning, and the at least one second terminal device is able to perform at least one second operation for positioning that is complementary to the first operation; and perform the first operation for positioning the target, a network node comprising: a processor; a memory storing instructions which, when executed by the processor, cause the processor to: determine that the first association is obtained among the first terminal device and the at least one second terminal device; and perform one or more third operations corresponding to the first operation and the at least one second operation for positioning the target.

In some embodiments, the instructions stored by the memory of the first terminal device, when executed by the processor of the first terminal device, cause the processor of the first terminal device to carry out any of the methods of the first aspect.

In some embodiments, the instructions stored by the memory of the network node, when executed by the processor of the network node, cause the processor of the network node to carry out any of the methods of the fourth aspect.

With some embodiments of the present disclosure, cooperation of UEs may be enabled in a complementary way to achieve better positioning results. This can allow, e.g., UEs with limited or reduced capability to enjoy the results from more resource-demanding positioning, based on a combined result combining individual complementary contributions of the individual UEs in the group.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunication network in which positioning based on multiple complementary operations is applicable according to an embodiment of the present disclosure.

FIG. 2 is a diagram illustrating an exemplary procedure for positioning a target by using multiple terminal devices according to an embodiment of the present disclosure.

FIG. 3 is a diagram illustrating exemplary UEs operating over complementary sets of frequency resources according to an embodiment of the present disclosure.

FIG. 4 is a diagram illustrating exemplary UEs operating over complementary sets of time/frequency resources according to an embodiment of the present disclosure.

FIG. 5 is a flow chart illustrating an exemplary method at a first terminal device for positioning a target that is associated with multiple terminal devices comprising the first terminal device according to an embodiment of the present disclosure.

FIG. 6 is a flow chart illustrating an exemplary method at a network node for positioning a target associated with multiple terminal devices comprising a first terminal device according to an embodiment of the present disclosure.

FIG. 7 schematically shows an embodiment of an arrangement which may be used in a terminal device or a network node according to an embodiment of the present disclosure.

FIG. 8 is a block diagram illustrating an exemplary terminal device according to an embodiment of the present disclosure.

FIG. 9 is a block diagram illustrating an exemplary network node according to an embodiment of the present disclosure.

FIG. 10 shows an example of a communication system in accordance with some embodiments of the present disclosure.

FIG. 11 shows an exemplary UE in accordance with some embodiments of the present disclosure.

FIG. 12 shows an exemplary network node in accordance with some embodiments of the present disclosure.

FIG. 13 is a block diagram of an exemplary host, which may be an embodiment of the host of FIG. 10, in accordance with various aspects described herein.

FIG. 14 is a block diagram illustrating an exemplary virtualization environment in which functions implemented by some embodiments may be virtualized.

FIG. 15 shows a communication diagram of an exemplary host communicating via an exemplary network node with an exemplary UE over a partially wireless connection in accordance with some embodiments of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as positioning based on multiple complementary operations are involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), future 6G systems, etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, an IoT device, a vehicle, or any other equivalents. For another example, the term “network node” used herein may refer to a base station, a base transceiver station, an access point, a hot spot, a NodeB (NB), an evolved NodeB (eNB), a gNB, a DoT, a network element, a network function, or any other equivalents. Further, the term “syncretizing”, “fusing”, “combining”, and “filtering” may be used interchangeably hereinafter. Further, the term “group” and “association” may be used interchangeably hereinafter. Further, the terms “multiple”, “a plurality of”, “more than one”, “two or more”, and “at least two” may be used interchangeably hereinafter.

Further, following 3GPP documents are incorporated herein by reference in their entireties:
3GPP TS 23.273 V18.0.0 (2022-12), Technical Specification, 3rd Generation Partnership Project; Technical Specification Group Services and System Aspects; 5G System (5GS) Location Services (LCS); Stage 2 (Release 18); and
3GPP TS 38.305 V17.4.0 (2023-03), Technical Specification, 3rd Generation Partnership Project; Technical Specification Group Radio Access Network; NG Radio Access Network (NG-RAN); Stage 2 functional specification of User Equipment (UE) positioning in NG-RAN (Release 17).

Further, following publications are incorporated herein by reference in their entireties:
Satyam Dwivedi, Ritesh Shreevastav, Florent Munier, Johannes Nygren, Iana Siomina, etc., “Positioning in 5G Networks,” IEEE Communications Magazine, vol. 59, no. 11, pp. 38-44, November 2021.

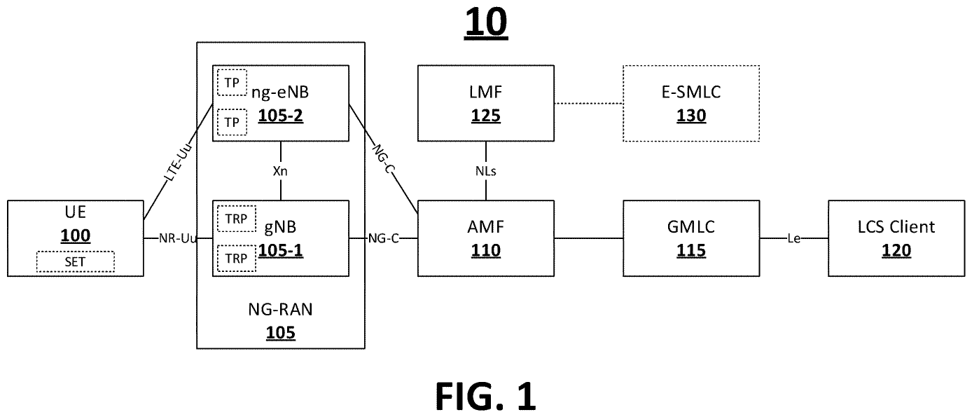

FIG. 1 is a diagram illustrating an exemplary telecommunication system 10 in which positioning based on multiple complementary operations is applicable according to an embodiment of the present disclosure. Although the telecommunication system 10 is a system defined in the context of 5GS, the present disclosure is not limited thereto. As shown in FIG. 1, the system 10 may comprise one or more UEs 100, a Radio Access Network (RAN) 105 and some network nodes/functions related to positioning.

In some embodiments, the RAN 105 may be a Next Generation RAN (NG-RAN). However, the present disclosure is not limited thereto. In some other embodiments, the RAN 105 may be an Evolved Universal Terrestrial Radio Access Network (E-UTRAN) or a RAN based on another RAT. Referring to FIG. 1, the NG-RAN 105 may comprise one or more RAN nodes, such as a gNB 105-1 and an ng-eNB 105-2, which may provide the UE 100 with access based on one or more Radio Access Technologies (RATs). For example, the gNB 105-1 may provide the UE 100 with NR access, and the ng-eNB 105-2 may provide the UE 100 with Evolved Universal Terrestrial Radio Access (E-UTRA) access. The RAN 105 may be involved in the handling of various positioning procedures including positioning of a target UE, provision of location related information not associated with a particular target UE and transfer of positioning messages between an AMF or LMF and a target UE. The RAN 105 may support determination of location estimates in geographical and/or local co-ordinates.

Further, as shown in FIG. 1, the system 10 may further comprise one or more network nodes, such as an AMF 110, a GMLC 115, an LCS client 120, an LMF 125, and an Enhanced Serving Mobile Location Center (E-SMLC) 130. Please note that the present disclosure is not limited thereto. In some other embodiments, the system 10 may comprise more nodes, less nodes, or different nodes that can be substituted for the nodes shown in FIG. 1.

In some embodiments, the AMF 110 may contain functionality responsible for managing positioning for a target UE for all types of location request. The AMF 110 may be accessible to the GMLC 115 via the Namf interface, to the RAN 105 via the N2 or NG-C reference point and to the UE 100 via the N1 reference point (which is enabled by the NG-C and NR-Uu/LTE-Uu reference points).

In some embodiments, the LMF 125 may manage the overall co-ordination and scheduling of resources required for the location of a UE that is registered with or accessing the 5G Core Network (CN). It may also calculate or verify a final location and any velocity estimate and may estimate the achieved accuracy. The LMF 125 may receive location requests for a target UE (e.g., the UE 100) from the serving AMF 110 using the Nlmf interface. The LMF 125 may interact with the UE 100 in order to exchange location information applicable to UE assisted and UE based positioning methods, and may interact with the NG-RAN 105 in order to obtain location information.

In some embodiments, the LMF 125 may determine the result of the positioning in geographical co-ordinates and/or in local co-ordinates. If requested and if available, the positioning result may also include the velocity of the UE 100. The coordinate type(s) may be determined by the LMF 125 when receiving a location request, based on LCS Client type and supported Geographical Area Description (GAD) shapes. If the location request indicates regulatory LCS Client type, the LMF 125 may determine a geographical location and optionally a location in local coordinates. For a location request that indicates a value added LCS Client type, the LMF 125 may determine the UE location in local coordinates or geographical co-ordinates or both. If the supported GAD shapes are not received or Local Co-ordinates are not included in the supported GAD shapes, the LMF 125 may determine a geographical location.

In some embodiments, the GMLC 115 may contain functionality required to support LCS. In one Public Land Mobile Network (PLMN), there may be more than one GMLC 115. The GMLC 115 may be the first node an external LCS client (e.g., the LCS client 120) accesses in a PLMN (i.e. the Le reference point is supported by the GMLC 115). Application Functions (AFs) and Network Functions (NFs) may access the GMLC 115 directly or via a Network Exposure Function (NEF). The GMLC 115 may request routing information and/or target UE privacy information from a UDM via the Nudm interface. After performing authorization of an external LCS Client or AF and verifying target UE privacy, the GMLC 115 may forward a location request to either a serving AMF (e.g., the AMF 110) using Namf interface or to a GMLC in another PLMN using the Ngmlc interface in the case of a roaming UE.

In some embodiments, AFs and NFs, as the LCS client 120, may access LCS services from the GMLC 115 in the same trust domain (e.g. in the same PLMN) using the Ngmlc interface or Event Exposure with location information from the AMF 110 in the same trust domain using the Namf interface. The LCS Client 120 may access LCS services from the GMLC 115 using the Le reference point. Further, external AFs may access LCS services from an NEF using Nnef interface or Common Application Programming Interface (API) Framework (CAPIF) for northbound APIs. Furthermore, the LCS Client 120 may access LCS services from a UE (e.g., the UE 100) over a user plane connection for reporting of location events by the UE for a periodic or triggered 5G Core Mobile Terminated Location Request (5GC-MT-LR) when the UE is able to determine location estimates.

As shown in FIG. 1 and also as mentioned above, the AMF 110 may receive a request for some location service associated with a particular target UE (e.g., the UE 100) from another entity (e.g., the GMLC 115 or another UE), or the AMF 110 itself may decide to initiate some location service on behalf of a particular target UE (e.g., for an Internet Protocol Multimedia System (IMS) emergency call from the UE). The AMF 110 may then send a location services request to the LMF 125. The LMF 125 may process the location services request which may include transferring assistance data to the target UE to assist with UE-based and/or UE-assisted positioning and/or may include positioning of the target UE. The LMF 125 may then return the result of the location service back to the AMF 110 (e.g., a position estimate for the UE). In the case of a location service requested by an entity other than the AMF 110 (e.g., the GMLC 115 or UE), the AMF 110 may return the location service result to this entity.

Further, as also shown in FIG. 1, an NG-RAN node (e.g., the gNB 105-1, the ng-eNB 105-2) may control several TRPs/Transmission Points (TPs), such as remote radio heads, or DL-PRS-only TPs for support of PRS-based Terrestrial Beacon System (TBS).

Further, the LMF 125 may have a proprietary signaling connection to the E-SMLC 130 which may enable the LMF 125 to access information from Evolved Universal Terrestrial Radio Access Network (E-UTRAN) (e.g. to support the OTDOA for E-UTRA positioning method using downlink measurements obtained by a target UE of signals from eNBs (e.g., the ng-eNB 105-2) and/or PRS-only TPs in E-UTRAN).

Some embodiments of the present disclosure propose methods to enable group-based positioning, in which a group may comprise at least two UEs complementing each other to enable positioning or to improve positioning quality for UEs in the group, based on their complementary operations enabling a combined or aggregated positioning result for the group. Examples of the complementary operations may comprise (but not limited to):
transmitting and/or receiving radio signals on complementary resources, e.g., any of:
   two time and/or frequency resource sets are complementary when their union is larger than any of them,
   two non-overlapping time and/or frequency resource sets can be complementary to each other,
performing one or more radio measurements on complementary resources.

In some embodiments, the methods can comprise (but not limited to), e.g., the following steps:
Step 0: Establishing a group of UEs with complementary responsibilities,
Step 1: Performing at least one operation in a complementary way,
Step 2: Using for positioning the result of the performing step.

In some embodiments, the steps can be implemented at a UE. In some embodiments, the steps can be implemented at a network node. In some embodiments, the steps can be jointly performed/implemented at both UE and network node.

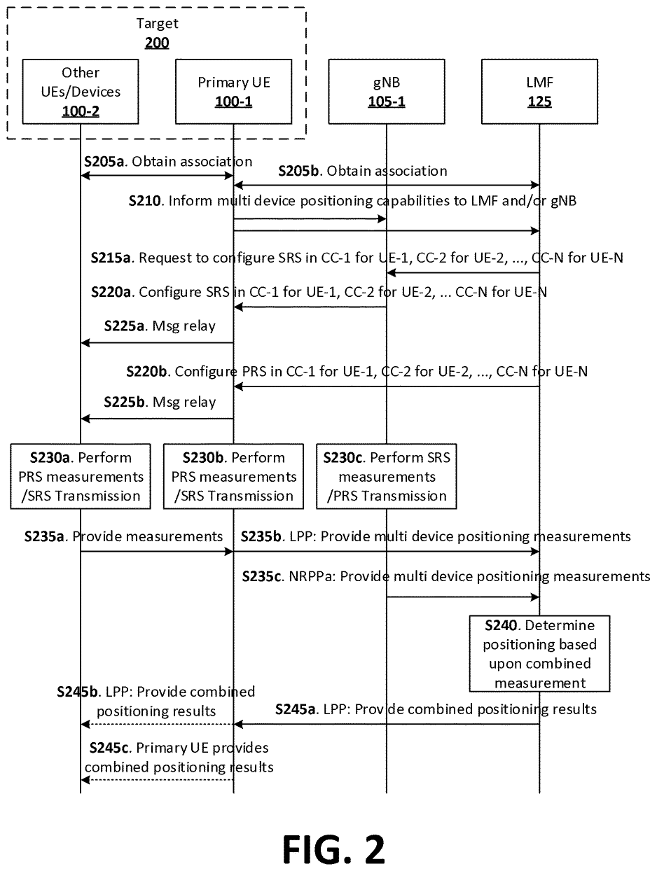

Next, an example signaling flow where network leverages the multi-device positioning (feature) by configuring positioning measurements (e.g., PRS and/or SRS based measurements) in complementary resources (e.g., different frequency carrier components or bandwidth parts) associated with different UEs in the same group will be described with reference to FIG. 2 in detail.

FIG. 2 is a diagram illustrating an exemplary procedure for positioning a target by using multiple terminal devices according to an embodiment of the present disclosure. As shown in FIG. 2, multiple UEs/devices 100-1 and 100-2 (collectively, UE/device 100) may be associated with a target 200. For example, the multiple UEs/devices 100 may be installed, attached, collocated, or otherwise associated to the target 200. In some embodiments, a multi-device positioning may be initiated with the network by a UE (e.g., the primary UE 100-1 or the other UEs/devices 100-2) in the group (directly with the network or via the primary UE 100-1). In some embodiments, a multi-device positioning can be initiated with the network by the primary UE 100-1.

The procedure may begin at step S205a or S205b where a group/association may be established, formed, or otherwise obtained for at least two devices/UEs (e.g., the primary UE 100-1 and the other UEs/devices 100-2). In some embodiments, the group/association may be formed by the at least two devices/UEs themselves at step S205a. In some other embodiments, the association may be configured from the LMF 125 to the at least two UEs/devices at S205b. In this case, the LMF 125 may configure the association to any of the at least two devices/UEs. For example, the LMF 125 may configure the association to the primary UE 100-1 such that the primary UE 100-1 may form the association with other UEs/devices 100-2. For another example, when there is no primary UE in the at least two UEs/devices, the LMF 125 may configure the association to one or more of the at least two UEs directly, such that the at least two UEs may form the association without a primary UE involved.

At step S210, the primary UE 100-1 may report multi-device capability to at least one of: radio base station node (e.g., the gNB 105-1) and Location server (e.g., an LMF 125).

At step S215a, the LMF 125 may request the gNB 105-1 to configure UL SRS for positioning using multiple component carrier configuration (different/distinct frequency region, BWPs) where each device may transmit SRS in one of the CC/BWP. Upon reception of the configuration, the gNB 105-1 may provide the UEs/devices in the group with corresponding configurations at steps S220a and S225a. Although it is shown in FIG. 2 that the configuration is forwarded by the primary UE 100-1 to other UEs/devices 100-2, the present disclosure is not limited thereto. For example, when there is no primary UE, the gNB 105-1 may provide the configurations to each of the UEs/devices in the group directly.

Further, at step S220b, the LMF 125 may configure the PRS measurement to each device in different Positioning Frequency layer (different/distinct frequency carriers, component carrier, BWP). Similar to the steps S220a and 225b, the LMF 125 may provide the configurations to the UEs/devices 100 directly or via the primary UE 100-1 at steps S220b and S225b.

Further, although it is shown in FIG. 2 that both configurations for SRS and PRS are provided to the UEs/devices 100, the present disclosure is not limited thereto. In some other embodiments, either of them may be not provided. In some other embodiments, a configuration for a different measurement type may be provided instead of or in addition to the SRS and/or PRS configurations.

At steps S230a, S230b, and/or S230c, the UEs/devices 100 and the gNB 105-1 may transmit SRS and PRS accordingly and respectively, and perform PRS and SRS measurements accordingly and respectively.

At steps S235a, S235b, and/or S235c, the LMF 125 may obtain the result from the UEs/devices 100 and/or the gNB 105-1, for example, using LPP and/or NRPPa.

At step S240, the LMF 125 may combine the results from multiple UEs/devices/network nodes into a combined positioning result.

At steps S245a, S245b, and S245c, one or more UEs/devices may receive a result of multi-device positioning comprising the combined positioning result or a refined result based on the combined positioning result. For example, any one or more of the below may apply:
the LMF 125 may provide the combined positioning result to the primary UE 100-1 (if such exists) at step S245a and/or to one or more other devices 100-2 in the group at step S245b via a positioning protocol (e.g., LPP or enhanced LPP);
The primary UE 100-1 may relay the combined positioning result to other UEs 100-2 in the group, at step S245c, via unicast, multicast, or broadcast;
The primary UE 100-1 may refine the combined positioning result, e.g., based on relative delays or offsets within the group, and send the refined result to one or more UEs 100-2 in the group, via unicast, multicast, or broadcast.

Some embodiments of the present disclosure propose methods to enable group-based positioning, in which a group may comprise at least two UEs complementing each other to enable positioning or to improve positioning quality for UEs in the group, based on their complementary operations enabling a combined positioning result for the group. Examples of the complementary operations may comprise but not limited to:
transmitting and/or receiving radio signals on complementary resources, e.g., any of:
   two time and/or frequency resource sets are complementary when their union is larger than any of them,
   two non-overlapping time and/or frequency resource sets can be complementary to each other,
performing one or more radio measurements on complementary resources.

With some embodiments of the present disclosure, cooperation of UEs may be enabled in a complementary way to achieve better positioning results. This can allow, e.g., UEs with limited or reduced capability to enjoy the results from more resource-demanding positioning, based on a combined result combining individual complementary contributions of the individual UEs in the group.

In some embodiments, methods are proposed to enable group-based positioning, in which a group comprises at least two UEs complementing each other to enable positioning or to improve positioning quality for UEs in the group, based on their complementary operations enabling a combined or aggregated positioning result for the group.

In some embodiments, the methods can comprise but not limited to, e.g., the following steps:
Step 0: Establishing a group of UEs with complementary responsibilities,
Step 1: Performing at least one operation in a complementary way,
Step 2: Using for positioning the result of the performing step.

In some embodiments, the steps can be implemented at a UE. In some embodiments, the steps can be implemented at a network node. In some embodiments, the steps can be jointly performed/implemented at both UE and network node.

In some embodiments, a group of UEs can comprise two or more UEs, in which the group may be characterized by physical proximity of the UEs of the group.

In some embodiments, the level of the physical proximity (e.g., within 1 meter or 5 meters) can be pre-configured, pre-defined, configured by an application or another node, e.g., a network node, or can be determined for UEs assigned to the group based on relative locations of UEs within the group.

In some embodiments, the group may change over time, e.g., one or more UEs leaving or joining, e.g., depending on the proximity to at least one of the other group members. For example, one UE can be forgotten at home or lost and therefore it needs to be removed from the group.

In some embodiments, a group can be characterized by a common ID, group ID, or have a common characteristic. In some embodiments, a group ID can also be used by any UE from the group to indicate its belonging to the group.

In some embodiments, one UE can be associated to only one group at a time. In some embodiments, one UE can be associated to up to M groups at a time, which may further depend on the UE capability. In some embodiments, different groups can be associated with different ranges (larger range-larger group). In some embodiments, different groups can be associated with different applications. In some embodiments, different groups can be associated with a different delay or timing. In some embodiments, different groups can be associated with a different user ID, Apple ID, etc.

In some embodiments, the relation among UEs in the group may be further characterized by any one or more of:
same ownership (same owner of all the UEs in the group),
same synchronization reference source or same SyncRef,
same group communication (e.g., via sidelink interface, PC5 interface, device-to-device links, Bluetooth, etc.),
registration to the same list (e.g., in a profile),
signing in under the same ID (e.g., Apple ID),
the same associated positioning request or measurement request (e.g., requesting to determine the location of the group of UEs or measurements to be performed by UEs in the group),
the same associated positioning result (e.g., location of the group of UEs),
common ID associated with the group,
for at least one radio measurement type (e.g., RSRP, timing measurement, Doppler, DL measurement, UL measurement, etc.), the measurement results associated with different UEs within the same group are the same or similar or have the same or similar characteristics (the two measurement results can comprise a first measurement result at UE1 and a second measurement result at UE2 for RS transmitted from the same network node; or the two measurement results are obtained by a network node based on RS1 received from UE1 and RS2 received from UE2 respectively), e.g.:
   RSRP1 and RSRP2 do not differ by more than a threshold,
   Two measurement results are characterized by the same or almost the same Doppler,
   Time of arrival 1 and time of arrival 2 do not differ by more than a threshold, etc.
same user or same carrier at the time of forming the association, e.g.:
   For example: only the devices used by a same person or a same carrier are used for positioning, but not the UE lent to a friend which is also nearby,
quasi-collocation (QCL): UEs in the same group or their radio signals can be defined as quasi-collocated or having the same or similar location or radio characteristics (e.g., Doppler characteristic, Doppler shift, Doppler spread, average delay, delay spread, power-delay profile, spatial receiver parameter, beam forming properties of the transmitted radio signals like dominant Angle of Arrival, average Angle of Arrival at the receiving side, etc.), in some examples,
common timing-related group (e.g., common Timing Error Group (TEG)): UEs in the same group or their radio signals can be associated with the same timing-related group, in some examples
   for example, multiple UEs can appear to another radio node (UE or radio network node) as one super UE with multiple antennas or antenna panels, where the delays between the transmissions/receptions from/at multiple UEs may differ by a value associated with a timing-related group.

In some embodiments, a group of UEs can correspond to the “J (J≥2) UEs carried by the same positioned target”, as described above.

In some embodiments, the complementary responsibilities may comprise configuring the UEs for one or more complementary operation(s), in which the complementary operation performed by UE1 may complement the operation(s) performed by other UE(s) in the same group and/or vice versa to enable a combined positioning result for the group. Examples of the complementary operations may comprise but not limited to:
transmitting and/or receiving radio signals on complementary resources, e.g., any of:
   two time and/or frequency resource sets are complementary when their union is larger than any one of them (e.g., group members may have some common resources but not all),
   two non-overlapping time and/or frequency resource sets can be complementary to each other,
performing one or more radio measurements on complementary resources.

In some embodiments, the primary (or anchor) UE may have some group responsibility, e.g., may perform one or more of:
configuring other UEs in the group (e.g., adding, removing, replacing, (de)activating the group membership, blocking temporarily within the group, controlling the UE rights within the group, controlling the UE priorities in the group, etc.),
maintaining the list of group members,
verifying whether a group member still meets a condition (e.g., proximity condition) for being in the group,
informing a network node about the group status (about UEs in the group, the number of UEs in the group, same or changed number of group members, about the leaving or joining group members, group association information, etc.),
acting towards at least one other node (e.g., a network node or another UE external to the group) on behalf of the plurality of the UEs in the group, e.g., radio measurement reporting, receiving a positioning request or measurement request or configuration for radio measurements to be performed by the group members, receiving assistance data for performing measurements by the group members,
   in one special non-limiting example, acting towards at least one other node (e.g., a network node or another UE external to the group) on behalf of the plurality of the UEs in the group, provided that other UEs in the group do not receive the positioning request or at least some configuration from a network node, which is performed by the primary UE instead,
relaying data between at least one UE in the group and a node external to the group (e.g., another UE or a network node),
distributing or forwarding to the group members at least some of the data/information or configuration received from a network node (the primary node may update the data/information/configuration or add some more data/information/configuration based on the primary node's knowledge of the group, prior to distributing to the group),
obtaining resources for the group, e.g., from a network node, and configuring the complementary resources for individual group members,
obtaining or determining and/or reporting a combined measurement result (or the eventual positioning result if UE-based positioning is considered) to a network node, based on the results of complementary operations of the group members,
being or providing a synchronization reference for other UEs in the group,
collecting radio measurements within the group,
forwarding or sending assistance data to the UEs in the group (e.g., for performing measurements based on radio signals transmitted by the network node and/or primary UE),
triggering UE members in the group to perform at least one positioning measurement,
comprising a Service Client for the group (e.g., LCS client) if the Service Client resides in the UE side,
performing resource coordination or allocation among UEs in the group.

In some embodiments, a primary UE can be a Quasi-Co-Location (QCL) reference for other UEs in the group. For example, at least one UE in the group can be quasi-collocated (QCL-ed) to the primary UE, or radio signals from the one UE in the group can be quasi-collocated (QCL-ed) to the primary UE, in which quasi-colocation is an indication of that the one UE in the group inherits some properties from the primary UE (e.g., location, velocity, or radio-related properties such radio conditions at its receiver, radio signal transmissions, etc.)

In some embodiments, a primary UE can be a reference point or reference location of the group. For example, the location of the primary UE can be used as a reference location for (relative) location of at least one UE in the group. In another example, the reference location for the group is not limited to be the location of some individual UE in the group (primary or any other UE), but can be a location of a virtual point (e.g., in the middle of group, having the shortest sum of the distances to all group members, determined to be within maximum X units from the most remote UE in the group, etc.).

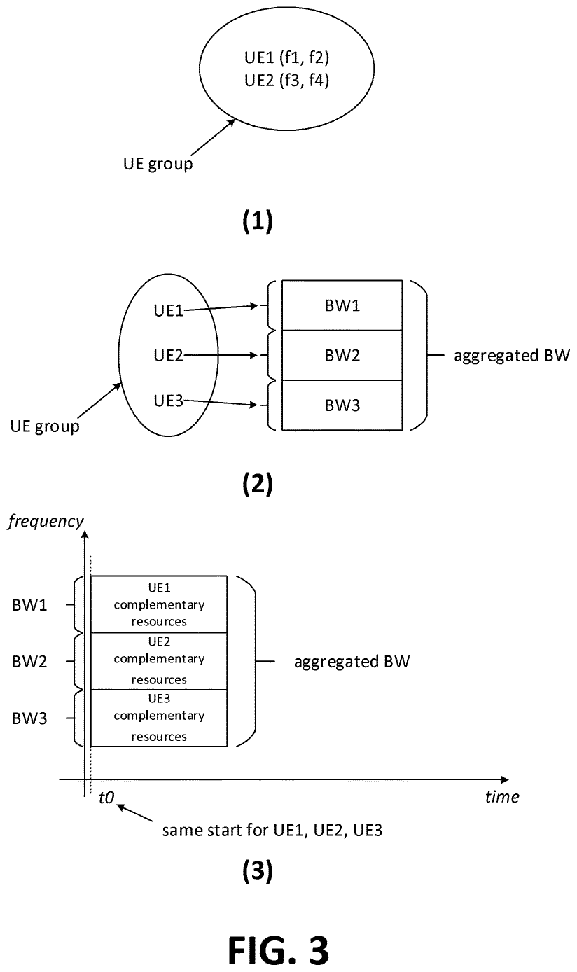

FIG. 3 is a diagram illustrating exemplary UEs operating over complementary sets of frequency resources according to an embodiment of the present disclosure. To be specific, an example with a group of UEs operating over two complementary sets of frequency resources is shown at (1) in FIG. 3. Further, an example with a group of UEs operating over three complementary sets of frequency resources or parts of a bandwidth, which can then be aggregated to obtain a combined positioning result, is shown at (2) in FIG. 3. In (2), the time resources may or may not be aligned for UE1, UE2, and UE3. Furthermore, an example with a group of three UEs operating (e.g., transmitting, receiving, or measuring) over three complementary sets of frequency resources or parts of a bandwidth, which can then be aggregated to obtain a combined positioning result, is shown at (3) in FIG. 3. In (3), the time resources are aligned.

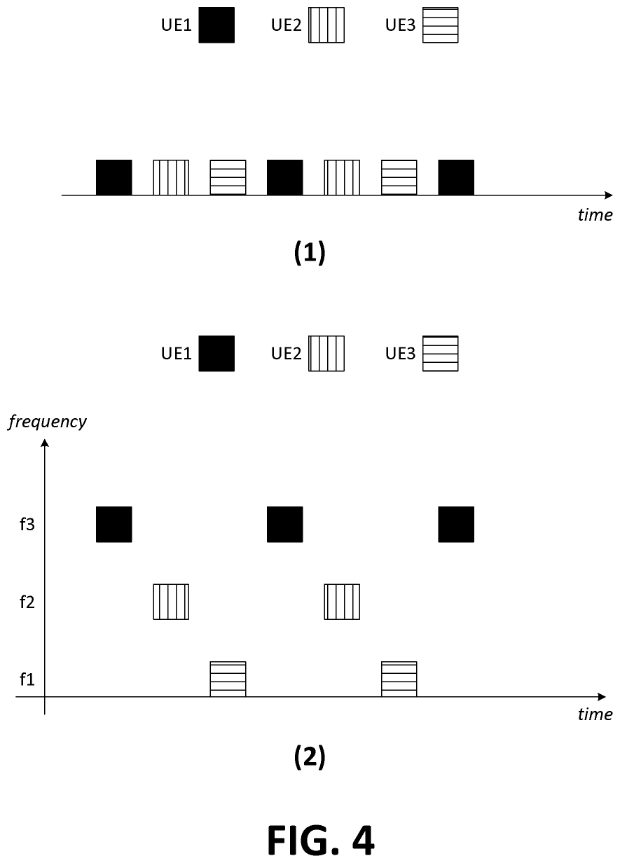

FIG. 4 is a diagram illustrating exemplary UEs operating over complementary sets of time/frequency resources according to an embodiment of the present disclosure. To be specific, an example with a group of UEs operating over three complementary sets of time resources is shown in FIG. 4 in which UEs with same frequency resources are shown at (1) in FIG. 4, and UEs with different frequency resources are shown at (2) in FIG. 4.

Example 1: In one example, see (1) in FIG. 3, the group and the group member UEs are configured to perform the complementary operations on different frequency resources, e.g., on different carrier frequencies, bandwidth parts, parts of the frequency band or frequency range, etc., e.g., UE1 on carrier frequencies f1 and f2, UE2 on carrier frequencies f3 and f4, etc.

Example 2: In another example, see (2) in FIG. 3, the frequency resources of the group member UEs may be aggregated to enable operations of the whole group over a larger bandwidth compared to its individual members and obtain a combined positioning result.

Example 3: In a more specific example, see (3) in FIG. 3, the frequency resources of the group member UEs may be staggered in frequency and specifically arranged in time to create a single block. For example, the resources can be time-aligned, i.e., the UEs in the group may perform the complementary operations at the same time, e.g., transmit and/or receive radio signals at the same time or in the same time resources, perform radio measurements in the same or aligned time resources, etc. In a special example, the complementary resources for different UEs in the same group may be comprised in the same radio frequency band and create a single intra-band transmission or intra-band reception block.
In some embodiments, if all UEs in the group transmit in the complementary resources arranged this way, the receiving radio node (e.g., a radio network node or another UE) may be able to treat the radio signals from the group of UEs as a single block, e.g., receive with a single FFT, perform a single measurement over a wider bandwidth comprising the complementary bandwidths of the individual UEs, etc.
In some embodiments, if all UEs in the group receive in the complementary resources arranged this way, the received (by different UEs in the group) parts of the radio signal (which could be transmitted by one radio node) can then be combined and processed together to obtain or reconstruct a received signal and/or radio measurement over a wider bandwidth comprising the complementary bandwidths of the individual UEs.

Example 4: In yet another example, see (1) and (2) in FIG. 4, the time resources for the group may be divided among three UEs in the group. (The three results obtained during the complementary operations on the divided resources can then be combined in a complementary way into one positioning result used in the next steps.) In this way, each UE is active at a fewer occasions (compared to when each UE needs to operate in all time resources configured for the group), which allows to save the UEs' energy.

In some embodiments, the term signal or radio signal or RS used herein can be any physical signal or physical channel. Physical signal may also be called reference signals (RS). Examples of DL physical signals are positioning signals, synchronization signals, PSS, SSS, CSI-RS, DMRS, signals in SSB, discovery reference signals, DRS, CRS, positioning reference signals (PRS), tracking signals, TRS, RLM signals, RLM-RS, beam management signals, BFD-RS, BM-RS, etc. Examples of UL physical signals are Sounding Reference Signals (SRS), DMRS etc. RS may be periodic, e.g., RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms. The SMTC occasion may contain one or more RSs such as SSBs. The term physical channel refers to any channel carrying higher layer information, e.g., data, control etc. Examples of physical channels are data channel, control channel, PBCH, NPBCH, PDCCH, PDSCH, sPUCCH, sPDSCH, sPUCCH, sPUSCH, MPDCCH, NPDCCH, NPDSCH, E-PDCCH, PUSCH, PUCCH, NPUSCH etc.

In some embodiments, a term node is used which can be a network node or a user equipment (UE).

In some embodiments, the non-limiting term UE may refer to any type of wireless device communicating with a network node and/or with another UE in a cellular or mobile communication system. Examples of UE are mobile device, target device, device to device (D2D) UE, vehicular to vehicular (V2V), sidelink (SL) UE, machine type UE, MTC UE or UE capable of machine to machine (M2M) communication, PDA, tablet, mobile terminals, smart phone, laptop embedded equipment (LEE), laptop mounted equipment (LME), USB dongles, smartphone, Apple iOS device, iPhone, iPod Touch, iPad, mobile device, digital media player, smartwatch, the Apple TV, the Apple Watch, reduced capacity or reduce capability UE, RedCap UE, NB-IoT UE, ambient IoT UE, etc. Some specific UE examples are a low-power UE, reduced capability UE (e.g., operating over a small BW, a limited set of frequency resources, generally less capable than normal UEs).

In some embodiments, the non-limiting term network node can comprise any of: physical network node, logical network node, radio network node, base station (BS), positioning node, Location Management Function, LMF, AMF, location measurement units, LMU, E-SMLC, NR base station, multi-standard radio (MSR) radio node such as MSR BS, NodeB, eNodeB, gNodeB, MeNB, SeNB, access point, network controller, radio network controller (RNC), base station controller (BSC), base transceiver station (BTS), Central Unit (e.g., in a gNB), Distributed Unit (e.g. in a gNB), Baseband Unit, Centralized Baseband, C-RAN, access point (AP), transmission points, transmission nodes, transmission point or TP, reception point or RP, transmission reception point (TRP), RRU, RRH, nodes in distributed antenna system (DAS), core network node (e.g., MSC, MME, etc), OAM, OSS, SON, etc.

In some embodiments, the term “measurements” or “radio measurements” herein may comprise any one or combination of: unidirectional measurement (e.g., Time of Arrival, RSRP), bidirectional measurement (e.g., RTT or rx-tx time difference measurement), RRM measurement (e.g., cell identification, SSB index, received signal strength, RSRP, PRP, received signal quality, RSRQ, SINR, RSSI, etc.), positioning measurement, ranging measurements, code phase measurements, pseudorange, Doppler measurements, carrier phase measurements, accumulated delta range, Doppler measurements, Doppler shift, Doppler frequency, velocity, timing measurements (e.g., TOA, RTOA, Rx-Tx time difference, RTT, timing advance, TDOA, propagation delay, delay spread, etc.), pathloss, angle measurements (angle of arrival, angle of departure), multipath measurements, timing of one or more correlation peaks, channel state or quality measurement or estimation (rank indication or RI, PMI, CSI, CQI etc.), radio link evaluation or monitoring (RLM), beam measurement (BM), BM may also be called as link recover procedure, beam evaluation or beam management, beam failure detection (BFD), candidate beam detection (CBD), signal detection, synchronization, L1 measurement, L2 measurement, L3 measurement, etc. RLM may further comprise of out of sync (OOS) detection, in-sync (IS) detection etc. Examples of L1 measurements are measurements performed for RLM, BM, L1-RSRP, L1-SINR etc.

In some embodiments, the term “time resource” or “time-frequency resource” used herein may correspond to any type of one or more physical resource or radio resource expressed in terms of length of time. The time resource configuration may also comprise muting configuration (e.g., an indication when a configured radio signal transmission is temporally not transmitted or ceased). A muting configuration may comprise a single or multiple time resources, a pattern, etc. Examples of time resources are one or more of:
symbol, time slot, subframe, radio frame, TTI, interleaving time, slot, sub-slot, mini-slot, resource element (RE), system frame number (SFN) cycle, hyper SFN (H-SFN) cycle, time-frequency resource, resource element or RE, etc.
a pattern (e.g., transmission pattern, receiving pattern, etc.),
periodic or aperiodic time resources,
time resources where the signal configuration further fulfills one or more additional conditions, e.g.:
   1) the signal in the time resource is on specific frequency resources [such as subcarriers, bandwidth, carrier frequency, etc.],
   2) the signal in the time resource is not configured for muting,
   3) time resources with pre-defined IDs, even IDs, odd IDs, etc.
occasion, RS occasion, receive occasion, transmit occasion, etc. Examples of RS occasion are SSB occasion of SSB, SMTC occasion of SMTC configuration, CSI-RS occasion of CSI-RS etc. An SSB occasion may comprise of one or more time resources (e.g. symbols) containing one or more SSBs. A CSI-RS occasion may comprise of one or more time resources (e.g. symbols) containing one or more CSI-RSs.

As mentioned above, the method may comprise three steps, Step 0, Step 1, and Step 2, and these steps will be described below in details.

Step 0: Establishing a Group of UEs with Complementary Responsibilities

In some embodiments, according to this step, a group of UEs with complementary responsibilities needs to be established. The step can comprise but not limited to, e.g., one or more of the establishing procedures below:
determining or configuring two or more members of the group,
   this may also comprise verifying the conditions characterizing the group (e.g., whether a UE is within a range, etc.)
updating the list of group members or group status, adding UEs to the group or removing UEs from the group, confirming whether a UE is still a group member based on their availability, proximity, etc.,
configuring of group resources and/or complementary resources,
   determining complementary resources (e.g., frequency, time resources, bandwidth) for at least one UE in the group based on its capability and group configuration (e.g., group resource pool, number of UEs in the group) by equal or weighted splitting of the group resource; more capable UE or UEs with more power or remaining energy can be assigned a larger portion or the more demanding part of the group resource pool
configuring of at least one complementary operation for one or more UEs in the group,
configuring a reference point for the group (e.g., reference point=primary UE location) or its characteristic or a condition to be met by the reference group (e.g., equally distant or at maximum distance X to any UE in the group) or the method which will be determine the reference point of the group
determining or configuring a primary or anchor UE within the group
   In some examples, the primary UE can be pre-configured, (de)configured by a network node, selected within a group based on pre-defined rules, elected among group members in the group.
   In some examples, the primary UE may even change over time
   A UE can be a primary UE, e.g., if one or more of the below applies:
      better connection to the network (e.g., with higher received signal strength or quality, with a communication link established, etc.),
      higher power or capacity,
      more battery energy left,
      enabling synchronization within the group, e.g., providing synchronization reference to the group or acting as a synchronization reference source to other UEs.
Sending to at least one node the result of at least one establishing procedure (sending the result of the establishing procedure may also comprise an implicit request associated with the group such as request for a network service, positioning service, communication service, data transmission, for resource allocation, etc.), e.g.,
   Sending by a network node a message indicative of the result or comprising the result to a node outside the group, e.g., another UE or network node,
   Sending by a UE a message indicative of the result or comprising the result to a node outside the group, e.g., another UE or network node,
   Sending by a network node a message indicative of the result or comprising the result to one or more UEs in the group, via unicast or multicast,
   Sending by a UE in the group a message indicative of the result or comprising the result to one or more other UEs in the group, via unicast or multicast.

In some embodiments, the results of the establishing procedures can comprise but not limited to, e.g., determining or obtaining any one or more of:
group attributes (e.g., group ID or common ID),
group members,
indication of which UE is the primary UE (if any), its ID, attributes, tx/rx configuration, etc.
group configuration (e.g., transmission configuration, receiver configuration, BW configuration, carrier frequency or frequency range configuration, etc.),
group characteristic (e.g., the maximum range or distance between UEs in the group, range or distance for a pair of UEs in the group, range or distance to a primary UE, relative location of UEs within the group, intra-group communication technology [Bluetooth, sidelink, device-to-device, etc.], etc.),
group capabilities (e.g., capabilities of individual UEs in the group, a common aggregated capability for the group, the union of capabilities in the group, the maximum and/or minimum capability of a specific type in the group such as maximum and/or minimum supported bandwidth among UEs in the group, UE types in the group, UE power class, etc.),
group resources (e.g., time- and/or frequency resources or a pattern for radio signal transmission, reception, radio measurements, resource pool for the group, etc.),
configuration of complementary resources for a UE in the group, complementary operation configuration (e.g., measurement configuration, transmission configuration, reception configuration, etc.),
group association (indicative to which group(s) a UE belongs),
a reference point for the group (e.g., reference point=primary UE location) or its characteristic or a condition to be met by the reference group (e.g., equally distant or at maximum distance X to any UE in the group) or the method which will be used for determining the reference point of the group.

In some embodiments, any of the establishing procedures above can be performed at a UE, at a network node (positioning node, LMF, BS, etc.) with or without UE assistance, or jointly at UE and network node. In some embodiments, the primary UE can be more involved in the establishing procedure and determining the result of the establishing than other UEs in the group.

In some embodiments, the establishing can further comprise transmitting one or more messages between a network node and at least one UE in the group, in which a message can comprise capability request/response (the capability related to the complementary operation in a group), providing or requesting a result of at least one establishing procedure, information about the group and group members, group status, etc. In some embodiments, the messages can be transmitted, e.g., via user-plane or control-plane higher layer protocols, such as LTE Positioning Protocol (LPP) or similar. Communication within the group can be via 3GPP or non-3GPP (e.g., Bluetooth) UE-to-UE interface, sidelink protocols, etc.

### Example Methods in UE at Step 0

performing at least one of the establishing procedures or assisting another UE or network node in performing at least one of the establishing procedures (e.g., assisting by indicating its availability, group-related capability or preference, indicating UE candidates to group members, indicating UE group members, providing measurements or data to assist in determining group resources or complementary resources, etc.);
obtaining at least one result of the establishing procedure(s), e.g., determining or receiving from another UE or network node;
   in some examples, the result can further be used as input to another establishing procedure to be performed by the UE
in some examples: further distributing the obtained result to at least one other UE in the group or to the network node.

### Example Methods in the Network Node at Step 0

performing at least one of the establishing procedures;
obtaining at least one result of the establishing procedure(s), e.g., determining or receiving from a UE (e.g., the group members can be pre-configured or decided by UEs in which case the information may need to be provided to the network node to be used by the network node for resource configuration, etc.);
   in some examples, the result can further be used as input to another establishing procedure to be performed by the network node;
in some examples: further distributing the obtained result to at least one other UE in the group or to the network node.

### Step 1: Performing at Least One Operation in a Complementary Way

In some embodiments, the step of performing at least one operation in a complementary way can comprise performing transmission, reception, or measuring on complementary resources (see, e.g., examples 1 to 4 above) in order to enable a combined or aggregated result for the group for positioning purpose. The combined/aggregated result is used for positioning the entire group or for positioning of one or more UEs in the group (e.g., exploiting the fact that the other UEs are in proximity or based on relative location knowledge within the group).

In some embodiments, a combined/aggregated result (Note: the terms “combined” or “aggregated” and “combining” and “aggregation/aggregating” can be used interchangeably herein, at least in some examples) can comprise, e.g., at least one of:
A procedure of combined reception or its result, based on complementary resources,
A procedure of combined transmission or its result, based on complementary resources,
A procedure of reception of a combined transmission or its result,
A procedure of combined measurement or the measurement combined measurement result, which may be based on complementary resources
   for a bidirectional measurement, the resources can be complementary in at least one direction (e.g., DL and/or UL resources; tx and/or rx resources),
A combined raw data set,
Combined measurement results from individual UEs or associated with individual UEs (e.g., in UL or in DL),
Combined samples,
A measurement over a bandwidth combined or at least two parts associated with different UEs in the group,
A combined power emission,
A radio signal based on a combination of at least two radio signal parts or replicas associated with at least two different UEs in the group,
A location determined for a reference point of the group,
An uncertainty of the group location, e.g., determined as the maximum range within the group or a function of a range within the group,
A combined positioning result determined based on complementary resources,
Determined location of one or more UEs in the group based on the reference location (the location of the UEs can be the same as the reference location, can be the same as the reference location but with uncertainty which does not exceed the maximum range within the group, can be determined based on the reference location by adding different offsets associated with different UEs in the group, in which the offsets can be based on relative distances between the UEs, etc.).

In some embodiments, obtaining a combined/aggregated result can also comprise at least one of: combining received signal instances received at or from different (at least two) UEs of the group over complementary resources, combining measurement results based on the received signal instances over complementary resources, receiving signal instances from different (at least two) UEs of the group as a single block or with a single FFT or for performing a single measurement, determining location or positioning results for individual UEs in the group based on the complementary resources and combining the multiple location or positioning results into a single combined location result associated with the group, obtaining a first positioning result based on a set of complementary resources associated with a first set of one or more UEs in the group and obtaining a refined (combined) second positioning result based on a set of complementary resources associated with a second set of one or more UEs in the group and on the first positioning result, etc.

In some embodiments, the combined/aggregated result can be obtained by at least one of:
a UE in the group (e.g., primary UE or other UE), e.g., a primary UE may receive or collect the radio signal reception/measurement results or raw data associated with complementary resources from the individual UEs in the group and combine them into a combined result;
a network node or UE outside the group, based on the results from the individual UEs in the group, when the individual results are sent (e.g., by the primary UE if such exists or by individual UEs of the group) to the network node or to the UE outside the group for combining them into a combined result; Examples of the network node: BS, LMF, positioning node, AMF, see other examples in the definition of a network node.
a node receiving the combined transmission (e.g., a network node or UE outside the group, etc.), by receiving the combined transmission from individual UEs in the group as a single block or with a single FFT or as a single measurement or combining the instances from the individual UEs (e.g., when the complementary resources are not overlapping in time) into a single measurement; in one example, the node may be able to receive with a single FFT and may not need to be even aware of that different UEs transmitted different parts of the block, while in another example, the node may apply some compensation to the signals received from different UEs in the same group before obtaining a combined result, in which the compensation can be based on the additional data (e.g., delays) associated with the complementary resources and the UEs in the group.

In some embodiments, combining/aggregation can be done, e.g., in time and/or frequency. Combining/aggregation in time can comprise, e.g., combining or accumulating together (e.g., as an operation of prioritizing LOS-resulted measurement with the prioritization granularity being UE, a uniform average, weighted average, linear sum, weighted sum, applying a pre-defined function on, etc.) the samples from individual UEs of the group. Combining/aggregation in frequency can comprise reconstructing a wider-bandwidth signal from individual instances, performing a wider-bandwidth measurement, combining or accumulating together the samples from individual UEs of the group (e.g., performing a uniform average for UE1's ToA measurement on frequency band ft and UE2's ToA measurement on frequency band f2 if UE1 works only on f1 and UE2 works only on f2), etc.

### Step 2: Using the Result of the at Least One Operation for Positioninq

In some embodiments, the combined/aggregated result can be used for positioning purpose, e.g.:
Determining location of at least one UE in the group;
Determining reference location of the group of the UEs or a common reference location for at least two UEs comprised in the same group;
Determining location of different UEs in the group, based on combined result or on the reference location determined based on the combined result, in which the location of individual UEs can be obtained as an offset to the reference location
   the offset(s) can be obtained, e.g., based on:
      radio measurements via UE-to-UE or sidelink interface;
      radio measurements at a network node (based at least on radio transmissions from group UEs received by the network node, but may also involve radio transmissions from the network node);
      radio measurements at primary UE (based at least on transmissions from group UEs received at the primary UE, but may also involve radio transmissions from the primary UE)
   An obtained offset can be signaled to another node, e.g.:
      First UE in the group->primary UE or second UE in the group
      Primary UE->network node
      Network node->primary UE
Signaling of the combined result to another node, e.g.:
   UE from the group->network node or UE outside the group
   Primary UE (e.g., obtaining the combined result)->network node or UE outside the group
   First network node (e.g., obtaining the result)->second network node
   Network node (e.g., obtaining the combine result)->primary UE or UE in the group
   Network node (obtaining the combine result)->UE outside the group
   First UE in the group->second UE in the group See the definitions of UE and network node for some examples.
Determining an area where the group UEs are located
Determining uncertainty or a quality metric of a positioning result associated with the group or at least one UE in the group, based on the combined result
Sending to at least one UE in the group (e.g., primary UE or other UE) or to another UE outside the group or network node a positioning result (which may also comprise a quality metric, uncertainty, etc.) associated with the group or at least one UE in the group, determined based on the methods described herein.

In some embodiments, a primary UE may report positioning result (e.g., RSTD result) in the way that for each device there is a positioning (e.g., RSTD measurement result) along with the complementary resources (e.g., frequencies in this example) where the positioning measurements were performed. In some embodiments, the further combining/aggregation into a single positioning result can then be done at a network node, e.g., LMF. Below is an exemplary ASN.1 for a combined measurement result list.

CombinedMeasurementResultList ::= SEQUENCE (SIZE
(2..maxNOfAssociatedResult)) OF MeasurementResult
MeasurementResult ::= SEQUENCE {

| dl-PRS-ID-r19 | INTEGER (0..255), | |
|---|---|---|
| nr-PhysCellID-r19 | NR-PhysCellID-r16 | |
| nr-CellGlobalID-r19 | NCGI-r15 | OPTIONAL, |

| nr-ARFCN-r19 | | ARFCN-ValueNR-r15 |
|---|---|---|
| nr-DL-PRS-ResourceID-r19 | | NR-DL-PRS-ResourceID-r16 |
| nr-DL-PRS-ResourceSetID-r19 | | NR-DL-PRS-ResourceSetID-r16 |
| nr-TimeStamp-r19 | | NR-TimeStamp-r16, |
| nr-RSTD-r19 | | CHOICE { |
| | k0-r19 | INTEGER (0..1970049), |
| | k1-r19 | INTEGER (0..985025), |
| | k2-r19 | INTEGER (0..492513), |
| | k3-r19 | INTEGER (0..246257), |
| | k4-r19 | INTEGER (0..123129), |
| | k5-r19 | INTEGER (0..61565), |

| | |
|---|---|
| } | ... |

}

With some embodiments of the present disclosure, cooperation of UEs may be enabled in a complementary way to achieve better positioning results. This can allow, e.g., UEs with limited or reduced capability to enjoy the results from more resource-demanding positioning, based on a combined result combining individual complementary contributions of the individual UEs in the group.

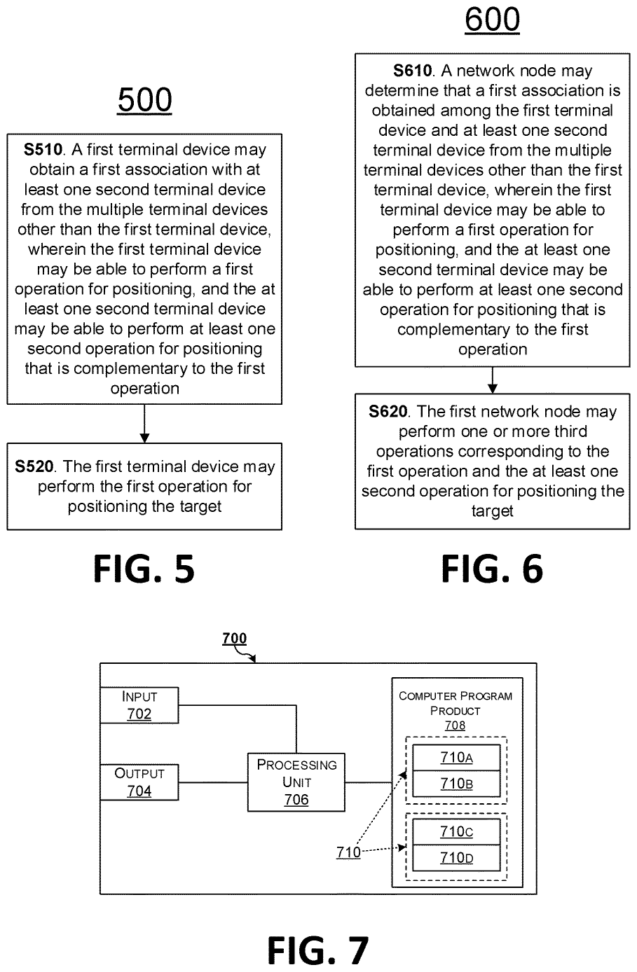

FIG. 5 is a flow chart of an exemplary method 500 at a first terminal device for positioning a target that is associated with multiple terminal devices comprising the first terminal device according to an embodiment of the present disclosure. The method 500 may be performed at a terminal device (e.g., the UE 100 shown in FIG. 1, the primary UE 100-1 and other UEs 100-2 shown in FIG. 2). The method 500 may comprise step S510 and Step S520. However, the present disclosure is not limited thereto. In some other embodiments, the method 500 may comprise more steps, less steps, different steps, or any combination thereof. Further the steps of the method 500 may be performed in a different order than that described herein. Further, in some embodiments, a step in the method 500 may be split into multiple sub-steps and performed by different entities, and/or multiple steps in the method 500 may be combined into a single step.

The method 500 may begin at step S510 where the first terminal device may obtain a first association with at least one second terminal device from the multiple terminal devices other than the first terminal device, the first terminal device may be able to perform a first operation for positioning, and the at least one second terminal device may be able to perform at least one second operation for positioning that is complementary to the first operation.

At step S520, the first terminal device may perform the first operation for positioning the target.

In some embodiments, the first terminal device may comprise a primary device among the multiple terminal devices. In some embodiments, the first operation and the at least one second operation may comprise at least one of: radio signal transmission for positioning; radio signal reception for positioning; and performing a radio measurement for positioning. In some embodiments, the first association may be formed based on at least the proximity. In some embodiments, the method 500 may further comprise at least one of: transmitting, to the at least one second terminal device, a message indicating or comprising a first result of the first operation; receiving, from a network node, a message comprising a positioning configuration for assisting the first terminal in performing the first operation; receiving, from a network node, a message comprising a positioning configuration for assisting the at least one second terminal in performing the second operation; receiving, from a network node, a message indicating or comprising a positioning result, based at least on the first operation and the at least one second operation; transmitting, to the at least one second terminal device, a message indicating or comprising a positioning configuration to assist the at least one second terminal device in performing the at least one second operation; transmitting, to a network node, a message indicating the first result of the first operation; receiving, from the at least one second terminal device, a message indicating at least one second result of the at least one second operation; transmitting, to a network node, a message indicating the at least one second result of the at least one second operation when the at least one second result is received from the at least one second terminal device; and obtaining a positioning result for the target, the positioning result may be based on at least the first result of the first operation and/or the at least one second result of the at least one second operation, the obtaining may comprise determining in the first terminal device or receiving from a network node. In some embodiments, a positioning configuration may comprise at least one of: a configuration for radio signals to be transmitted for positioning; a configuration for radio signals to be received for positioning; and a configuration for positioning measurement.

In some embodiments, the first operation may be complementary to the at least one second operation in terms of radio resource sets associated to the first operation and the at least one second operation. In some embodiments, a union of a first radio resource set associated with the first operation and at least one second radio resource set associated with the at least one second operation may be a proper superset of the first radio resource set and a proper superset of the at least one second radio resource set. In some embodiments, the first radio resource set may be not overlapped with the second radio resource set in the frequency domain, or in the time domain, or in both of the frequency domain and the time domain.

In some embodiments, the first operation may comprise at least one of: transmitting first radio signals over a first radio resource set associated with the first operation that is complementary to a second radio resource set associated with the at least one second operation; receiving second radio signals over a first radio resource set associated with the first operation that is complementary to a second radio resource set associated with the at least one second operation; and performing one or more measurements over a first radio resource set associated with the first operation that is complementary to a second radio resource set associated with the at least one second operation. In some embodiments, the first radio signals may be Sounding Reference Signals (SRS). In some embodiments, the second radio signals may be Positioning Reference Signals (PRS).

In some embodiments, before the step of performing the first operation, the method 500 may further comprise at least one of: informing one or more network nodes about a first positioning capability of the first terminal device; and informing one or more network nodes about a positioning capability comprising a first positioning capability of the first terminal device and at least one second positioning capability of the at least one second terminal device. In some embodiments, before the step of informing the one or more network nodes about the first positioning capability, the method 500 may further comprise: receiving, from the at least one second terminal device, a message indicating at least one second positioning capability of the at least one second terminal device, the step of informing the one or more network nodes about the first positioning capability may comprise: informing the one or more network nodes about both the first positioning capability and the at least one second positioning capability. In some embodiments, the one or more network nodes may be informed about the first positioning capability by the first terminal device via the at least one second terminal device. In some embodiments, the method 500 may further comprise: receiving, from the one or more network nodes and/or the at least one second terminal device, a message indicating a first positioning configuration for the first terminal device, the step of performing the first operation may be based on at least the first positioning configuration.

In some embodiments, when at least one second positioning configuration for the at least one second terminal device is received by the first terminal device from the one or more network nodes, the method 500 may further comprise: transmitting, to each of the at least one second terminal device, a message indicating a corresponding one of the at least one second positioning configuration. In some embodiments, the one or more network nodes may comprise at least one of: a Radio Access Network (RAN) node; a positioning node; an Access and Mobility Management Function (AMF); a Location Measurement Unit (LMU); an Enhanced Serving Mobile Location Centre (E-SMLC); and a Location Management Function (LMF).

In some embodiments, a positioning configuration for a terminal device may comprise at least one of: a configuration indicating an uplink (UL) radio resource set for the terminal device to transmit SRS; a configuration indicating a downlink (DL) radio resource set for the terminal device to receive PRS; and a measurement configuration for the terminal device to perform a measurement based on at least one of SRS and PRS. In some embodiments, after the step of transmitting the first result, the method 500 may further comprise at least one of: receiving, from the at least one second terminal device, a positioning result for the target; receiving, from a network node, a positioning result for the target; refining the positioning result, when it is received from the network node, based on relative delays and/or offsets between members in the first association; and transmitting, to the at least one second terminal device, the positioning result, when it is received from the network node, or the refined positioning result.

In some embodiments, the first association may have a higher physical proximity level for its members than a threshold. In some embodiments, the threshold may be determined by at least one of: a pre-configuration; a dynamic configuration by an application; a dynamic configuration by a network node or another terminal device; and relative locations of the members in the first association. In some embodiments, the method 500 may further comprise at least one of: associating the first terminal device with a third terminal device based on at least the third terminal device's physical proximity level to at least one member in the first association, such that the third terminal device joins the first association; and disassociating the first terminal device from another terminal device in the first association based on at least the other terminal device's physical proximity level to one or more of other members in the first association, such that the other terminal device leaves the first association.

In some embodiments, the first terminal device may be not able to obtain another association than the first association. In some embodiments, the first terminal device may be able to obtain one or more other associations than the first association. In some embodiments, each of the one or more other associations may have a physical proximity level different from that of the first association. In some embodiments, each of the one or more other associations may be associated with an application different from that associated with the first association. In some embodiments, each of the one or more other associations may be associated with a delay or timing different from that associated with the first association. In some embodiments, each of the one or more other associations may be associated with an identifier different from that associated with the first association.

In some embodiments, the members in the first association may have at least one of: a same ownership; a same synchronization reference source; same group communication; registrations to a same list; sign-ins under a same identifier; a same associated positioning request or measurement request; a same associated positioning result; a same quasi-collocation (QCL) type; a common timing-related group; a common ID associated with the first association; for at least one radio measurement type, related measurement results that are close to each other to an extent defined by one or more thresholds; and a same user or same carrier at the time of obtaining the first association. In some embodiments, the measurement results that are close to each other to an extent defined by one or more thresholds may comprise at least one of: Reference Signal Received Powers (RSRPs) measured by the members in the first association that do not differ from each other by more than a threshold; measurement results for Doppler measurements performed by the members in the first association that do not differ from each other by more than a threshold; and Time of Arrivals (ToAs) measured for the members in the first association that do not differ from each other by more than a threshold.

In some embodiments, the first terminal device may be a primary terminal device for the first association. In some embodiments, with respect to other members in the first association, the first terminal device may have at least one of: a better connection to the network; a higher power; a higher capacity; more battery energy left; and a capability of enabling synchronization within the group. In some embodiments, the primary terminal device may be able to perform at least one of: configuring other members in the first association; maintaining a list of members in the first association; verifying whether a member in the first association still meets a condition for being in the first association; informing a network node about a status of the first association; acting towards at least one other node on behalf of members in the first association; relaying data between at least one member in the first association and a node external to the first association; distributing or forwarding, to members in the first association, at least some of the data and/or information and/or configuration received from a network node; obtaining resources for the first association; configuring complementary resources for individual members in the first association; obtaining and/or determining and/or reporting a combined measurement result to a network node based on results of complementary operations of members in the first association; being or providing a synchronization reference for other members in the first association; collecting radio measurements within the first association; forwarding or sending assistance data to members in the first association; triggering members in the first association to perform at least one positioning measurement; comprising a Service Client for the first association if the Service Client resides in the terminal device side; and performing resource coordination or allocation among members in the first association.

In some embodiments, the primary terminal device may be able to be a QCL reference for other terminal devices in the first association. In some embodiments, the primary terminal device may be able to be used as a reference location for at least one of other terminal devices in the first association. In some embodiments, radio resource sets associated with the members in the first associations may be consecutive in the frequency domain and aligned in the time domain. In some embodiments, signals transmitted by the members in the first association over the radio resource sets associated with the members in the first association may be able to be received and/or processed by a same node as a combined signal transmitted over a bandwidth comprising the individual bandwidths of the individual radio resource sets associated with the individual members in the first association. In some embodiments, signals received by the members in the first association over the radio resource sets associated with the members in the first association may be able to be combined and processed as a combined signal received over a bandwidth comprising the individual bandwidths of the individual radio resource sets associated with the individual members in the first association. In some embodiments, measurement results measured by the members in the first association over the radio resource sets associated with the members in the first association may be able to be combined and processed as a combined measurement result measured over a bandwidth comprising the individual bandwidths of the individual radio resource sets associated with the individual members in the first association.

In some embodiments, only when the first operation performed by the first terminal device is a reception operation of downlink (but not a transmission operation of downlink) and when there is a UE that will be fully responsible for feedbacking positioning-related downlink measurement results to the network side and when this responsible UE is one of the at least one second terminal device, the first terminal device will send the first result of the first operation to the responsible second terminal device.

In some embodiments, only when the at least one second operation performed by the at least one second terminal device is a reception operation of downlink (but not a transmission operation of downlink) and when the first terminal device is the only UE that will be fully responsible for feedbacking positioning-related downlink measurement results to the network side, the receiving and transmitting behavior in the corresponding descriptions will exist.

In some embodiments, the method may further comprise at least one of transmitting from the first terminal device, to one or more network nodes, a first positioning capability which is a multi-device positioning capability (e.g., regular positioning capability along with the association-related info), and transmitting from each of the at least one second terminal device, to one or more network nodes, a corresponding second positioning capability which is a multi-device positioning capability (e.g., regular positioning capability along with the association-related info).

In some embodiments, before the step of performing the first operation, the method may further comprise at least one of: receiving at the first terminal device, from each of the at least one second terminal device, a message indicating a corresponding second positioning capability, then, informing one or more network nodes about both the first positioning capability of the first terminal device and the corresponding second positioning capabilities of the at least one second terminal device, or receiving at one of the at least one second terminal device, from each of the first terminal device and all other second terminal devices, a message indicating a corresponding positioning capability, then, informing one or more network nodes about both the first positioning capability of the first terminal device and the corresponding second positioning capabilities of the at least one second terminal device.

In some embodiments, the method 500 may further comprise: transmitting, to the at least one second terminal device, the positioning result or the refined positioning result, when only the first terminal device received the positioning result from the network node, the refined positioning result is obtained by a refining operation of the first terminal device for the positioning result according to relative delays and/or offsets between members in the first association.

In some embodiments, the primary terminal device is able to perform at least one of: acting on behalf of the association towards nodes external to the association; performing at least one radio measurement configured for the association; transmitting at least one radio signal configured for the association; reporting radio measurements on behalf of the association; receiving a request for one or more radio measurements to be performed by the members in the association on behalf of the members in the association; forwarding assistance data to the at least one second terminal device; triggering the at least one second terminal device to perform positioning measurements; collecting radio measurements from the at least one second terminal device; acting as a synchronization reference to the at least one second terminal device; providing another node external to the association with information about the association; and informing another node external to the association about a change in the association.

FIG. 6 is a flow chart of an exemplary method 600 at a network node for positioning a target associated with multiple terminal devices comprising a first terminal device according to an embodiment of the present disclosure. The method 600 may be performed at a network node (e.g., the gNB 105-1 or the LMF 125 shown in FIG. 1). The method 600 may comprise step S610 and step S620. However, the present disclosure is not limited thereto. In some other embodiments, the method 600 may comprise more steps, less steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where the network node may determine that a first association is obtained among the first terminal device and at least one second terminal device from the multiple terminal devices other than the first terminal device, the first terminal device is able to perform a first operation for positioning, and the at least one second terminal device is able to perform at least one second operation for positioning that is complementary to the first operation.

At step S620, the network node may perform one or more third operations corresponding to the first operation and the at least one second operation for positioning the target.

In some embodiments, the first terminal device may comprise a primary device among the multiple terminal devices. In some embodiments, the first operation, the at least one second operation, and the one or more third operations may comprise at least one of: radio signal transmission for positioning; radio signal reception for positioning; and performing a radio measurement for positioning. In some embodiments, the first association may be formed based on at least the proximity. In some embodiments, the method 600 may further comprise at least one of: receiving, from one or more members in the first association, one or more messages indicating a first result of the first operation and/or at least one second result of the at least one second operation; transmitting, to the first terminal device and/or the at least one second terminal device, a message comprising a positioning configuration for assisting the first terminal in performing the first operation; transmitting, to the first terminal device and/or the at least one second terminal device, a message comprising a positioning configuration for assisting the at least one second terminal in performing the second operation; transmitting, to the first terminal device and/or the at least one second terminal device, a message indicating or comprising a positioning result, based at least on the first operation and the at least one second operation; transmitting, to one or more nodes, one or more messages indicating at least one of the first result, the at least one second result, and one or more third results of the one or more third operations; and obtaining a positioning result for the target, the positioning result may be based on at least one of the first result, the at least one second result, and the one or more third results, the obtaining may comprise determining in the first terminal device or receiving from a network node. In some embodiments, a positioning configuration may comprise at least one of: a configuration for radio signals to be transmitted for positioning; a configuration for radio signals to be received for positioning; and a configuration for positioning measurement.

In some embodiments, the first operation may be complementary to the at least one second operation in terms of radio resource sets associated to the first operation and the at least one second operation. In some embodiments, a union of a first radio resource set associated with the first operation and at least one second radio resource set associated with the at least one second operation may be a proper superset of the first radio resource set and also a proper superset of the at least one second radio resource set. In some embodiments, the first radio resource set may be not overlapped with the second radio resource set in the frequency domain, or in the time domain, or in both of the frequency domain and the time domain.

In some embodiments, the one or more third operations may comprise at least one of: receiving first radio signals over one or more radio resource sets associated with one or more complementary operations performed by one or more members in the first association; transmitting second radio signals over one or more radio resource sets associated with one or more complementary operations performed by one or more members in the first association; performing one or more measurements over one or more radio resource sets associated with one or more complementary operations performed by one or more members in the first association. In some embodiments, the first radio signals may be Sounding Reference Signals (SRS). In some embodiments, the second radio signals may be Positioning Reference Signals (PRS).

In some embodiments, before the step of performing the one or more third operations, the method 600 may further comprise at least one of: receiving, from one or more members in the first association, one or more messages indicating one or more positioning capabilities of the one or more members in the first association. In some embodiments, the method 600 may further comprise at least one of: receiving, from one or more other network nodes, one or more messages indicating one or more positioning configurations for the one or more members in the first association; and transmitting, to the one or more members in the first association, one or more messages indicating one or more positioning configurations for the one or more members in the first association.

In some embodiments, the network node may comprise at least one of: a Radio Access Network (RAN) node; a positioning node; an Access and Mobility Management Function (AMF); a Location Measurement Unit (LMU); an Enhanced Serving Mobile Location Centre (E-SMLC); and a Location Management Function (LMF). In some embodiments, a positioning configuration for a member in the first association may comprise at least one of: a configuration indicating an uplink (UL) radio resource set for the member to transmit SRS; a configuration indicating a downlink (DL) radio resource set for the member to receive PRS; and a measurement configuration for the member to perform a measurement based on at least one of SRS and PRS.

In some embodiments, after the step of positioning the target, the method 600 may further comprise at least one of: transmitting, to one or more members in the first association, one or more messages indicating a positioning result for the target. In some embodiments, the first association may have a higher physical proximity level for its members than a threshold. In some embodiments, the threshold may be determined by at least one of: a pre-configuration; a dynamic configuration by an application; a dynamic configuration by a network node or another terminal device; and relative locations of the members in the first association.

In some embodiments, the method 600 may further comprise at least one of: configuring one or more members in the association and a third terminal device based on at least the third terminal device's physical proximity level to at least one member in the first association such that the third terminal device joins the first association; receiving, from one or more members in the association, one or more messages indicating that a third terminal device joins the first association; configuring one or more members in the association based on at least a member terminal device's physical proximity level to other members in the first association such that the member terminal device in the first association leaves the first association; and receiving, from one or more members in the association, one or more messages indicating that a member in the first association leaves the first association.

In some embodiments, the method 600 may further comprise: determining that one or more other associations than the first association are obtained by the first terminal device. In some embodiments, each of the one or more other associations may have a physical proximity level different from that of the first association. In some embodiments, each of the one or more other associations may be associated with an application different from that associated with the first association. In some embodiments, each of the one or more other associations may be associated with a delay or timing different from that associated with the first association. In some embodiments, each of the one or more other associations may be associated with an identifier different from that associated with the first association.

In some embodiments, the members in the first association may have at least one of: a same ownership; a same synchronization reference source; same group communication; registrations to a same list; sign-ins under a same identifier; a same associated positioning request or measurement request; a same associated positioning result; a same quasi-collocation (QCL) type; a common timing-related group; a common ID associated with the first association; for at least one radio measurement type, related measurement results that are close to each other to an extent defined by one or more thresholds. In some embodiments, the measurement results that are close to each other to an extent defined by one or more thresholds may comprise at least one of: Reference Signal Received Powers (RSRPs) measured by the members in the first association that do not differ from each other by more than a threshold; measurement results for Doppler measurements performed by the members in the first association that do not differ from each other by more than a threshold; and Time of Arrivals (ToAs) measured for the members in the first association that do not differ from each other by more than a threshold.

In some embodiments, the method 600 may further comprise: determining that the first terminal device is a primary terminal device for the first association. In some embodiments, with respect to other members in the first association, the first terminal device may have at least one of: a better connection to the network; a higher power; a higher capacity; more battery energy left; and a capability of enabling synchronization within the group. In some embodiments, the primary terminal device may be able to perform at least one of: configuring other members in the first association; maintaining a list of members in the first association; verifying whether a member in the first association still meets a condition for being in the first association; informing a network node about a status of the first association; acting towards at least one other node on behalf of members in the first association; relaying data between at least one member in the first association and a node external to the first association; distributing or forwarding, to members in the first association, at least some of the data and/or information and/or configuration received from a network node; obtaining resources for the first association; configuring complementary resources for individual members in the first association; obtaining and/or determining and/or reporting a combined measurement result to a network node based on results of complementary operations of members in the first association; being or providing a synchronization reference for other members in the first association; collecting radio measurements within the first association; forwarding or sending assistance data to members in the first association; triggering members in the first association to perform at least one positioning measurement; comprising a Service Client for the first association if the Service Client resides in the terminal device side; and performing resource coordination or allocation among members in the first association.

In some embodiments, the primary terminal device may be able to be a QCL reference for other terminal devices in the first association. In some embodiments, the primary terminal device may be able to be used as a reference location for at least one of other terminal devices in the first association. In some embodiments, radio resource sets associated with the members in the first associations may be consecutive in the frequency domain and aligned in the time domain. In some embodiments, signals transmitted by the members in the first association over the radio resource sets associated with the members in the first association may be able to be received and/or processed by the network node as a combined signal transmitted over a bandwidth comprising the individual bandwidths of the individual radio resource sets associated with the individual members in the first association. In some embodiments, signals transmitted by the network node over the radio resource sets associated with the members in the first association may be able to be received by the members in the first association, respectively, and combined and processed as a combined signal received over a bandwidth comprising the individual bandwidths of the individual radio resource sets associated with the individual members in the first association. In some embodiments, signals transmitted by the network node over the radio resource sets associated with the members in the first association may be able to be measured by the members in the first association, respectively, and measurement results are able to be combined and processed as a combined measurement result measured over a bandwidth comprising the individual bandwidths of the individual radio resource sets associated with the individual members in the first association.

FIG. 7 schematically shows an embodiment of an arrangement which may be used in a network node and/or a terminal device according to an embodiment of the present disclosure. Comprised in the arrangement 700 are a processing unit 706, e.g., with a Digital Signal Processor (DSP) or a Central Processing Unit (CPU). The processing unit 706 may be a single unit or a plurality of units to perform different actions of procedures described herein. The arrangement 700 may also comprise an input unit 702 for receiving signals from other entities, and an output unit 704 for providing signal(s) to other entities. The input unit 702 and the output unit 704 may be arranged as an integrated entity or as separate entities.

Furthermore, the arrangement 700 may comprise at least one computer program product 708 in the form of a non-volatile or volatile memory, e.g., an Electrically Erasable Programmable Read-Only Memory (EEPROM), a flash memory and/or a hard drive. The computer program product 708 comprises a computer program 710, which comprises code/computer readable instructions, which when executed by the processing unit 706 in the arrangement 700 causes the arrangement 700 and/or the network node and/or the terminal device in which it is comprised to perform the actions, e.g., of the procedure described earlier in conjunction with FIG. 2, FIG. 5, and FIG. 6 or any other variant.

The computer program 710 may be configured as a computer program code structured in computer program modules 710A and 710B. Hence, in an exemplifying embodiment when the arrangement 700 is used in a first terminal device for positioning a target that is associated with multiple terminal devices comprising the first terminal device, the code in the computer program of the arrangement 700 includes: a module 710A configured to obtain a first association with at least one second terminal device from the multiple terminal devices other than the first terminal device, the first terminal device is able to perform a first operation for positioning, and the at least one second terminal device is able to perform at least one second operation for positioning that is complementary to the first operation; and a module 710B configured to perform the first operation for positioning the target.

Additionally or alternatively, the computer program 710 may be further configured as a computer program code structured in computer program modules 710C and 710D. Hence, in an exemplifying embodiment when the arrangement 700 is used in a network node for positioning a target associated with multiple terminal devices comprising a first terminal device, the code in the computer program of the arrangement 700 includes: a module 710C configured to determine that a first association is obtained among the first terminal device and at least one second terminal device from the multiple terminal devices other than the first terminal device, the first terminal device is able to perform a first operation for positioning, and the at least one second terminal device is able to perform at least one second operation for positioning that is complementary to the first operation; and a module 710D configured to perform one or more third operations corresponding to the first operation and the at least one second operation for positioning the target

The computer program modules could essentially perform the actions of the flow illustrated in FIG. 2, FIG. 5, and FIG. 6, to emulate the terminal device and/or the network node. In other words, when the different computer program modules are executed in the processing unit 706, they may correspond to different modules in the network node and/or the terminal device.

Although the code means in the embodiments disclosed above in conjunction with FIG. 7 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network node and/or terminal device.

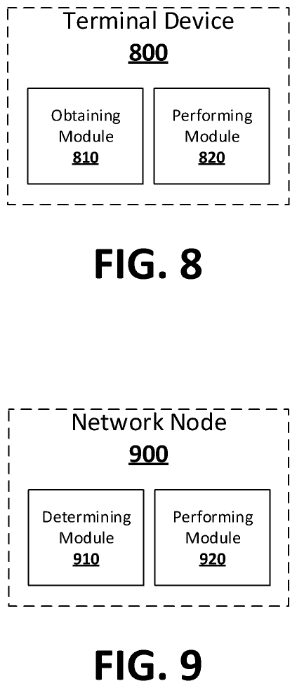

Correspondingly to the method 500 as described above, an exemplary first terminal device for positioning a target that is associated with multiple terminal devices comprising the first terminal device is provided. FIG. 8 is a block diagram of an exemplary terminal device 800 according to an embodiment of the present disclosure. The terminal device 800 may be, e.g., the UE 100 or the primary UE 100-1 or other UEs/devices 100-2 in some embodiments.

The terminal device 800 may be configured to perform the method 500 as described above in connection with FIG. 5. As shown in FIG. 8, the terminal device 800 may comprise: an obtaining module 810 configured to obtain a first association with at least one second terminal device from the multiple terminal devices other than the first terminal device, the first terminal device is able to perform a first operation for positioning, and the at least one second terminal device is able to perform at least one second operation for positioning that is complementary to the first operation; and a performing module 820 configured to perform the first operation for positioning the target

The above modules 810 and/or 820 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the terminal device 800 may comprise one or more further modules, each of which may perform any of the steps of the method 500 described with reference to FIG. 5.

Correspondingly to the method 600 as described above, an exemplary network node for positioning a target associated with multiple terminal devices comprising a first terminal device comprising the first terminal device is provided. FIG. 9 is a block diagram of an exemplary network node 900 according to an embodiment of the present disclosure. The network node 900 may be, e.g., the gNB 105-1 or the LMF 125 in some embodiments.

The network node 900 may be configured to perform the method 600 as described above in connection with FIG. 6. As shown in FIG. 9, the network node 900 may comprise: a determining module 910 configured to determine that a first association is obtained among the first terminal device and at least one second terminal device from the multiple terminal devices other than the first terminal device, the first terminal device is able to perform a first operation for positioning, and the at least one second terminal device is able to perform at least one second operation for positioning that is complementary to the first operation; and a performing module 920 configured to perform one or more third operations corresponding to the first operation and the at least one second operation for positioning the target

The above modules 910 and/or 920 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 6. Further, the network node 900 may comprise one or more further modules, each of which may perform any of the steps of the method 600 described with reference to FIG. 6.

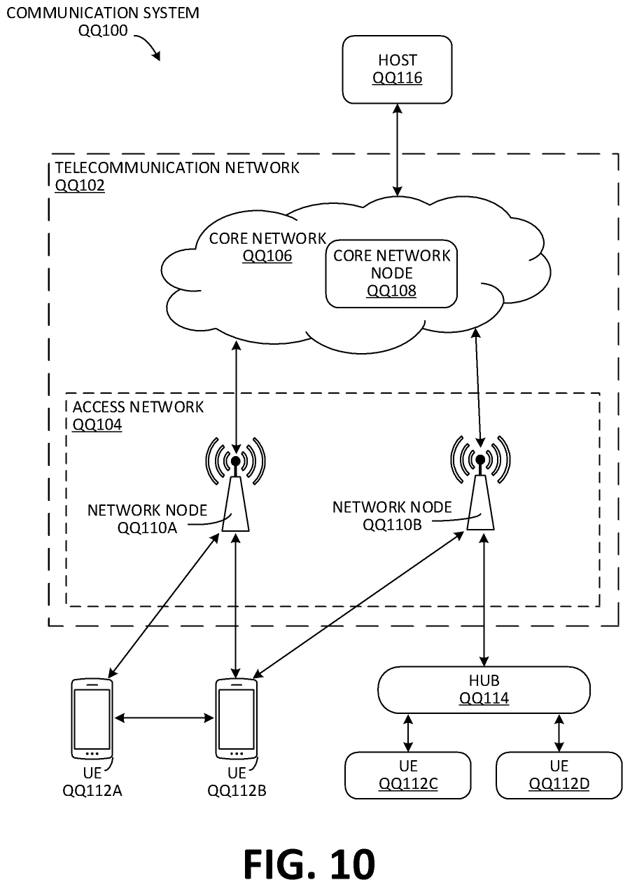

FIG. 10 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

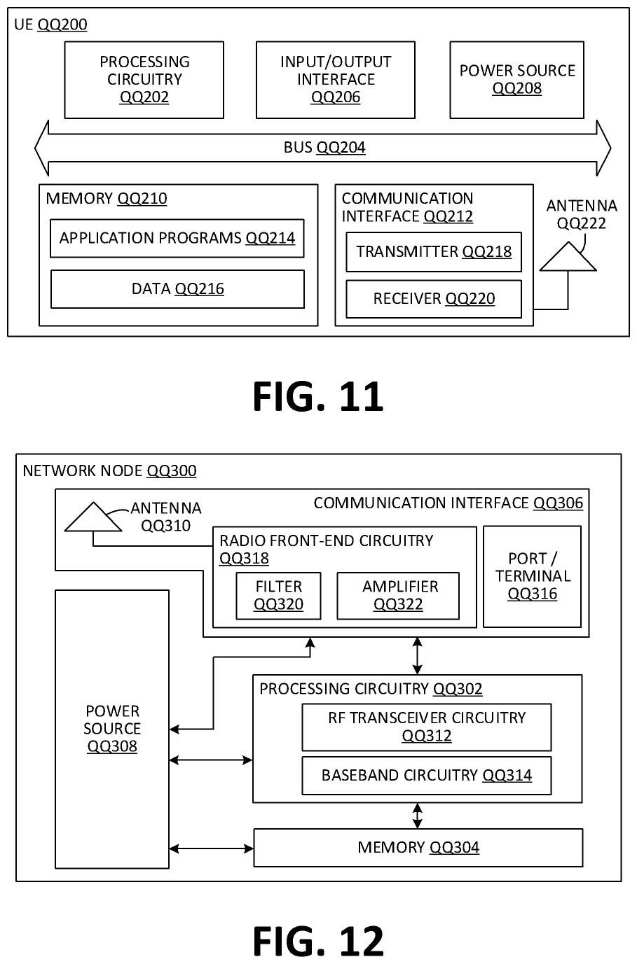

FIG. 11 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322.

The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 12 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

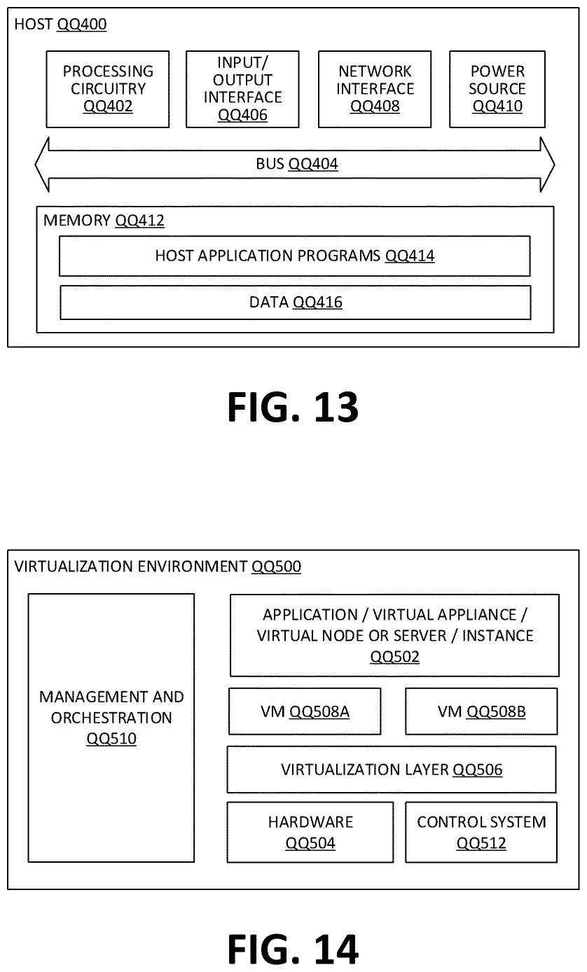

FIG. 13 is a block diagram of a host QQ400, which may be an embodiment of the host QQ116 of FIG. 10, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 11 and FIG. 12, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

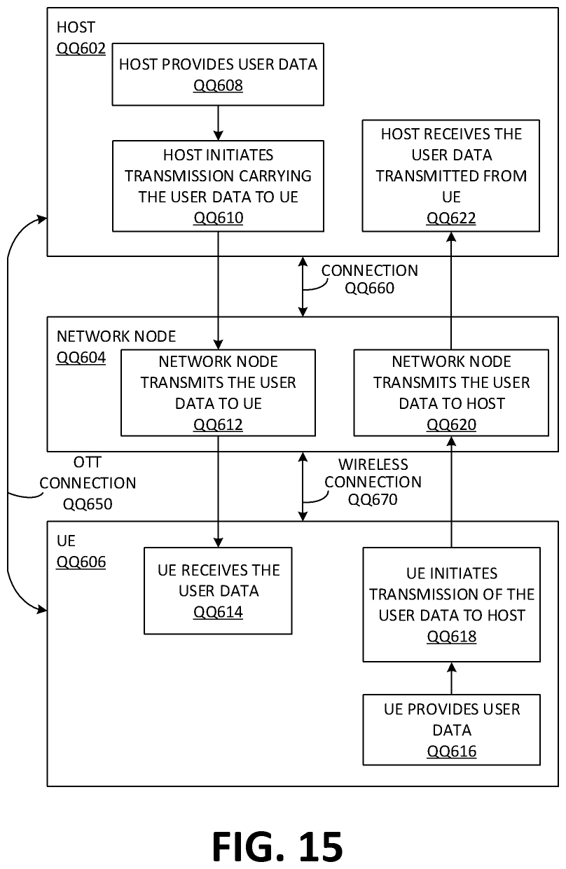

FIG. 15 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 10 and/or UE QQ200 of FIG. 11), network node (such as network node QQ110a of FIG. 10 and/or network node QQ300 of FIG. 12), and host (such as host QQ116 of FIG. 10 and/or host QQ400 of FIG. 13) discussed in the preceding paragraphs will now be described with reference to FIG. 15.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 10) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AoA | Angle of Arrival |
| L1, L2, L3 | Layer 1, Layer 2, Layer 3 |
| PRS | Positioning Reference Signal |
| PSS | Primary Synchronization Signal |
| RS | Reference Signal |
| RSRP | Reference Signal Received Power |
| RSRQ | Reference Signal Received Quality |
| RSSI | Received Signal Strength Indicator |
| RTOA | Relative Rime Of Arrival |
| RTT | Round Trip Time |
| SINR | Signal-to-Noise and Interference Ratio |
| SMTC | SSB Measurement Timing Configuration |
| SRS | Sounding Reference Signal |
| SSB | Synchronization Signal and PBCH Block |
| SSS | Secondary Synchronization Signal |
| TA | Timing Advance |
| TDOA | Time Difference Of Arrival |
| TOA | Time Of Arrival |
| TRP | Transmission and/or Reception Point |
| UE | User Equipment |

1.-83. (canceled)

84. A method at a first terminal device for positioning a target that is associated with multiple terminal devices comprising the first terminal device, the method comprising:
obtaining a first association with at least one second terminal device from the multiple terminal devices other than the first terminal device, wherein the first terminal device is able to perform a first operation for positioning, and the at least one second terminal device is able to perform at least one second operation for positioning that is complementary to the first operation; and
performing the first operation for positioning the target.

85. The method of claim 84, wherein:
the first terminal device comprises a primary device among the multiple terminal devices; and/or
the first operation and the at least one second operation comprise at least one of:
radio signal transmission for positioning;
radio signal reception for positioning; and
performing a radio measurement for positioning.

86. The method of claim 84, wherein the first association is formed based on at least a proximity between the first terminal device and the at least one second terminal.

87. The method of claim 84, further comprising at least one of:
transmitting, to the at least one second terminal device, a message indicating or comprising a first result of the first operation;
receiving, from a network node, a message comprising a positioning configuration for assisting the first terminal in performing the first operation;
receiving, from a network node, a message comprising a positioning configuration for assisting the at least one second terminal in performing the second operation;
receiving, from a network node, a message indicating or comprising a positioning result, based at least on the first operation and the at least one second operation;
transmitting, to the at least one second terminal device, a message indicating or comprising a positioning configuration to assist the at least one second terminal device in performing the at least one second operation;
transmitting, to a network node, a message indicating the first result of the first operation;
receiving, from the at least one second terminal device, a message indicating at least one second result of the at least one second operation;
transmitting, to a network node, a message indicating the at least one second result of the at least one second operation when the at least one second result is received from the at least one second terminal device; and
obtaining a positioning result for the target, wherein the positioning result is based on at least the first result of the first operation and/or the at least one second result of the at least one second operation, wherein the obtaining comprises determining the positioning result in the first terminal device or receiving the positioning result from a network node.

88. The method of claim 87, wherein a positioning configuration comprises at least one of:
a configuration for radio signals to be transmitted for positioning;
a configuration for radio signals to be received for positioning; and
a configuration for a positioning measurement.

89. The method of claim 84, wherein:
the first operation comprises at least one of:
transmitting first radio signals over a first radio resource set associated with the first operation that is complementary to a second radio resource set associated with the at least one second operation;
receiving second radio signals over a first radio resource set associated with the first operation that is complementary to a second radio resource set associated with the at least one second operation; and
performing one or more measurements over a first radio resource set associated with the first operation that is complementary to a second radio resource set associated with the at least one second operation; and/or
the method further comprises, before performing the first operation, at least one of:
informing one or more network nodes about a first positioning capability of the first terminal device; and
informing one or more network nodes about a positioning capability comprising a first positioning capability of the first terminal device and at least one second positioning capability of the at least one second terminal device.

90. The method of claim 89, wherein:
the one or more network nodes are informed about the first positioning capability by the first terminal device via the at least one second terminal device; and/or
the method further comprises, before informing the one or more network nodes about the first positioning capability, receiving, from the at least one second terminal device, a message indicating at least one second positioning capability of the at least one second terminal device, wherein informing the one or more network nodes about the first positioning capability comprises informing the one or more network nodes about both the first positioning capability and the at least one second positioning capability.

91. The method of claim 89, further comprising receiving, from the one or more network nodes and/or the at least one second terminal device, a message indicating a first positioning configuration for the first terminal device, wherein performing the first operation is based on at least the first positioning configuration.

92. The method of claim 91, wherein the method further comprises, when at least one second positioning configuration for the at least one second terminal device is received by the first terminal device from the one or more network nodes, transmitting, to each of the at least one second terminal device, a message indicating a corresponding one of the at least one second positioning configuration.

93. The method of claim 87, further comprising, after transmitting the first result, at least one of:
receiving, from the at least one second terminal device, a positioning result for the target;
receiving, from a network node, a positioning result for the target;
refining the positioning result, when it is received from the network node, based on relative delays and/or offsets between members in the first association; and
transmitting, to the at least one second terminal device, the positioning result, when it is received from the network node, or the refined positioning result.

94. The method of claim 84, wherein the first association has a higher physical proximity level for its members than a threshold.

95. The method of claim 94, wherein the threshold is determined by at least one of:
a pre-configuration;
a dynamic configuration by an application;
a dynamic configuration by a network node or another terminal device; and
relative locations of the members in the first association.

96. The method of claim 84, further comprising at least one of:
associating the first terminal device with a third terminal device based on at least the third terminal device's physical proximity level to at least one member in the first association, such that the third terminal device joins the first association; and
disassociating the first terminal device from another terminal device in the first association based on at least the other terminal device's physical proximity level to one or more of other members in the first association, such that the other terminal device leaves the first association.

97. The method of claim 84, wherein members in the first association have at least one of:
a same ownership;
a same synchronization reference source;
same group communication;
registrations to a same list;
sign-ins under a same identifier;
a same associated positioning request or measurement request;
a same associated positioning result;
a same quasi-collocation (QCL) type;
a common timing-related group;
a common ID associated with the first association;
for at least one radio measurement type, related measurement results that are close to each other to an extent defined by one or more thresholds; and
a same user or same carrier at the time of obtaining the first association.

98. The method of claim 97, wherein the measurement results that are close to each other to an extent defined by one or more thresholds comprise at least one of:
Reference Signal Received Powers (RSRPs) measured by the members in the first association that do not differ from each other by more than a threshold;
measurement results for Doppler measurements performed by the members in the first association that do not differ from each other by more than a threshold; and
Time of Arrivals (ToAs) measured for the members in the first association that do not differ from each other by more than a threshold.

99. The method of claim 84, wherein the first terminal device is a primary terminal device for the first association, and wherein the primary terminal device is able to perform at least one of:
configuring other members in the first association;
maintaining a list of members in the first association;
verifying whether a member in the first association still meets a condition for being in the first association;
informing a network node about a status of the first association;
acting towards at least one other node on behalf of members in the first association;
relaying data between at least one member in the first association and a node external to the first association;
distributing or forwarding, to members in the first association, at least some of the data and/or information and/or configuration received from a network node;
obtaining resources for the first association;
configuring complementary resources for individual members in the first association;
obtaining and/or determining and/or reporting a combined measurement result to a network node based on results of complementary operations of members in the first association;
being or providing a synchronization reference for other members in the first association;
collecting radio measurements within the first association;
forwarding or sending assistance data to members in the first association;
triggering members in the first association to perform at least one positioning measurement;
comprising a Service Client for the first association if the Service Client resides in the terminal device side; and
performing resource coordination or allocation among members in the first association.

100. The method of claim 84, wherein radio resource sets associated with members in the first associations are consecutive in the frequency domain and aligned in the time domain.

101. The method of claim 100, wherein:
signals transmitted by the members in the first association over the radio resource sets associated with the members in the first association are able to be received and/or processed by a same node as a combined signal transmitted over a bandwidth comprising individual bandwidths of individual radio resource sets associated with the individual members in the first association; and/or
signals received by the members in the first association over the radio resource sets associated with the members in the first association are able to be combined and processed as a combined signal received over a bandwidth comprising the individual bandwidths of the individual radio resource sets associated with the individual members in the first association; and/or
measurement results measured by the members in the first association over the radio resource sets associated with the members in the first association are able to be combined and processed as a combined measurement result measured over a bandwidth comprising the individual bandwidths of the individual radio resource sets associated with the individual members in the first association.

102. A first terminal device for positioning a target that is associated with multiple terminal devices comprising the first terminal device, the first terminal device comprising:
a processor;
a memory storing instructions which, when executed by the processor, cause the processor to:
obtain a first association with at least one second terminal device from the multiple terminal devices other than the first terminal device, wherein the first terminal device is able to perform a first operation for positioning, and the at least one second terminal device is able to perform at least one second operation for positioning that is complementary to the first operation; and
perform the first operation for positioning the target.

103. A method at a network node for positioning a target associated with multiple terminal devices comprising a first terminal device, the method comprising:
determining that a first association is obtained among the first terminal device and at least one second terminal device from the multiple terminal devices other than the first terminal device, wherein the first terminal device is able to perform a first operation for positioning, and the at least one second terminal device is able to perform at least one second operation for positioning that is complementary to the first operation; and
performing one or more third operations corresponding to the first operation and the at least one second operation for positioning the target.
